(19) United States
(12) Patent Application Publication
(10) Pub. No.: US 2008/0103913 A1
(43) Pub. Date: May 1, 2008

(54) SYSTEM AND METHOD FOR GUIDED SALES

(75) Inventors: Brian Robert Leach, Mechanicsville, VA (US); Lisa Hendrickson Janzer, Glen Allen, VA (US); Hunter Ridgley Shomo, Richmond, VA (US); Kevin Mack Leetham, Richmond, VA (US); David J. Romero, Midlothian, VA (US); Oliver Sulse Cortum, Richmond, VA (US); Michael Laskaris, Richmond, VA (US); Daniel James Bohn, Midlothian, VA (US)

Correspondence Address: BANNER & WITCOFF, LTD., 1100 13th STREET, N.W., SUITE 1200, WASHINGTON, DC, 20005-4051, US

(73) Assignee: CIRCUIT CITY STORES INC., Richmond, VA (US)

(21) Appl. No.: 11/553,092

(22) Filed: Oct. 26, 2006

(51) Int. Cl. G06Q 30/00

(52) U.S. Cl. 705/26

(57) ABSTRACT

A guided sales system provides a sales person and/or a customer with guidance through a sales process including detailed information about products and technologies. The guided sales system allows a user to enter information about the customer and the customer's needs, to identify products matching the customer's needs and to make product recommendations. A user may further use the system to print a recommendation and/or a sales ticket that may be used by a customer to complete a purchase or transaction. The sales system may further provide a free-form drawing application to help visualize product placement and configurations. Various visualization and learning tools may further be integrated into or otherwise included in the guided sales system to aid a customer's understanding of particular products and/or technologies.

### BACKGROUND

For consumers, customer service is often a significant factor in determining whether they will purchase a product. Customer service representatives may influence a consumer's purchasing decision by providing additional or different information about a product. Sales associates may further make recommendations or identify products that may be particularly suited to the consumer's needs and/or preferences. Such selective product identification and recommendation may lead to a higher probability that the consumer will make a purchase. In one example, a sales associate may show a consumer certain digital camera products based on the consumer's desired use and functionality. If the consumer is looking for a digital camera for producing high quality photographs, the consumer may be more likely to purchase a 5 megapixel camera than a 2 megapixel digital camera.

To facilitate guided sales, customer service representatives may often be provided with sales training and sales software to help the representatives direct consumers to appropriate products. However, many guided sales systems lack tools to help a consumer visualize differences in products or product technologies. For example, it may be difficult to identify resolution differences between high definition televisions displaying images in 1080 p resolution versus 780 p resolution simply by looking at the televisions. Other product attributes including camera filter effects, image quality and image contrast may also be hard to determine just by viewing the products themselves.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A guided sales system according to one or more aspects may include multiple options for guiding a customer in developing a product solution. For example, the sales system may allow a sales associate or customer to open a saved recommendation or solution, access a product catalog, access learning and visualization tools or start a new guided sales solution. Starting a new guided sales solution allows a sales associate or customer to enter customer information such as name, contact information, currently owned products, desired use of the product and other relevant information. In one or more arrangements, a sales associate may further enter drawings such as room drawings into the sales system. This may allow a customer to visualize product placement and room configurations. Further, the sales associate or customer may input such drawings in a free-form manner (e.g., freehand drawings). That is, the sales associate or customer may draw a room or other object free-hand using input devices such as a stylus or finger and a touch/stylus-sensitive or digitizing display device. Once customer information has been entered, product parameters may be determined from the information. Products matching the parameters may then be listed for the sales associate or customer's perusal prior to making a recommendation. The sales associate may make a manual recommendation or may elect to have the system make automatic recommendations after he or she has finished reviewing the product listing. During the guided sales process, a sales associate or customer may access various functions and applications provided in the guided sales system without interruption. Thus, in one example, a sales associate or customer may seamlessly jump from viewing a product listing back to entering customer information.

According to one or more aspects, the guided sales system may be used to train sales persons while on the job. That is, a sales person may learn questions to ask, technology differences, product locations and other sales information by using the guided sales system while interacting with customers. This allows a store to reduce or eliminate the need for sales persons to undergo training courses prior to stepping on the sales floor.

In an alternative or additional aspect, a guided sales system may be deployed such that a customer may interact with the system independently (i.e., without a sales person). For example, the guided sales system may be implemented on a self-service kiosk in the store or on the store's website. Such uses of the guided sales system may expedite a customer's shopping by allowing the customer to find the product he or she wants prior to arriving at the store. Further, customers who might not be inclined to engage a sales associate may be encouraged to shop at the store if the guided sales system were available for them to use independently (e.g., at a self-service kiosk or in the comfort of their home).

In another aspect, solution information may be saved to a central server or system that is accessible by multiple devices and systems. Thus, a sales person or customer who starts a solution at a first store may subsequently retrieve and access the same solution at a second store. Changes made to a solution at a first location and/or through a first device may be reflected when accessing the solution at a second location and/or through a second device. In another example, a customer may initiate a solution at home through a store or company website and later retrieve, modify and/or complete the solution at a local store. Alternatively or additionally, solution information may be accessed simultaneously by multiple different devices and/or in multiple different locations. For example, a customer support specialist may view and otherwise access solution information simultaneously with a customer at home.

In another aspect, the guided sales system may allow a sales associate to print out a sales ticket or recommendation that includes information needed for the customer to complete a purchase/transaction. For example, the sales ticket may include product bar codes, brand information, model numbers and the like. A recommendation may include additional information such as details about the recommended product, the sales person's name and contact information, store information, price and availability information and the like. A customer may proceed to a checkout counter with just the sales ticket or recommendation to complete the purchase. In one or more configurations, recommendation and sales ticket information may be electronically transmitted to a point of sale system, such as a store checkout register, where a transaction may be completed. The customer, upon arriving at the register, may identify the recommendation and sales ticket information based on a customer name, solution ID, phone number and/or various other identification information.

According to yet another aspect, the guided sales system may be implemented on a handheld mobile device that is capable of wireless communications. The mobile device may include caching means for storing product and store information. The device may further be linked to an in-store server and/or a central corporate server for retrieving additional or new information. In one or more configurations, product and store information may be replicated to the device overnight during low traffic times. Alternatively or additionally, the guided sales system may be deployed on a desktop computing device using wired or wireless communications.

According to still another aspect, the guided sales system may include multiple visualization and/or learning tools that simulate various aspects of a product or technology. Such tools may aid a customer in visualizing differences in and aspects of products and/or technologies. Learning and visualization tools may include a magnification tool for visualizing resolution differences, filter effect tools for visualizing the effects of camera filters, zoom/crop tools for visualizing differences in image quality, zoom lens tools for visualizing a zoomable distance and an ambient light effect tool for simulating the effects of ambient light on different types of televisions (e.g., LCD versus plasma). These tools may include additional features such as interactive controls for adjusting a degree of polarization of a camera filter and controlling the amount of ambient light in a simulated room. In one or more embodiments, a sales associate may access these tools from the guided sales system and may return to a guided sales solution seamlessly. Alternatively or additionally, the learning tools may further include audio overlays for narrating product and/or technology features.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates a network architecture for communicating sales, product and customer data according to one or more aspects described herein.

FIGS. 2A and 2B are flowcharts illustrating a method for guiding a user in identifying one or more products suitable for a consumer according to one or more aspects described herein.

FIGS. 3A-3N illustrate various user interfaces corresponding to a guided sales system according to one or more aspects described herein.

FIGS. 4A and 4B illustrate a screen resolution visualization tool according to one or more aspects described herein.

FIG. 5 is a flowchart illustrating a method for simulating the magnification of an image according to one or more aspects described herein.

FIGS. 6A and 6B illustrate two filter effect visualization tools according to one or more aspects described herein.

FIG. 7 is a flowchart illustrating a method for simulating camera filter effects according to one or more aspects described herein.

FIGS. 8A-8C illustrate a zoom visualization tool according to one or more aspects described herein.

FIGS. 9A and 9B illustrate a tool for simulating differences between cropping and enlarging images having varying image qualities according to one or more aspects described herein.

FIGS. 10A and 10B illustrate a tool for simulating differences between zooming in images of different image qualities according to one or more aspects described herein.

FIG. 11 is a flowchart illustrating a method for simulating the zooming and enlarging of an image according to one or more aspects described herein.

FIGS. 12A-12C illustrate an ambient light tool for simulating the effects of ambient light on different television technologies according to one or more aspects described herein.

### DETAILED DESCRIPTION

In the following description of various illustrative embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope of the present invention.

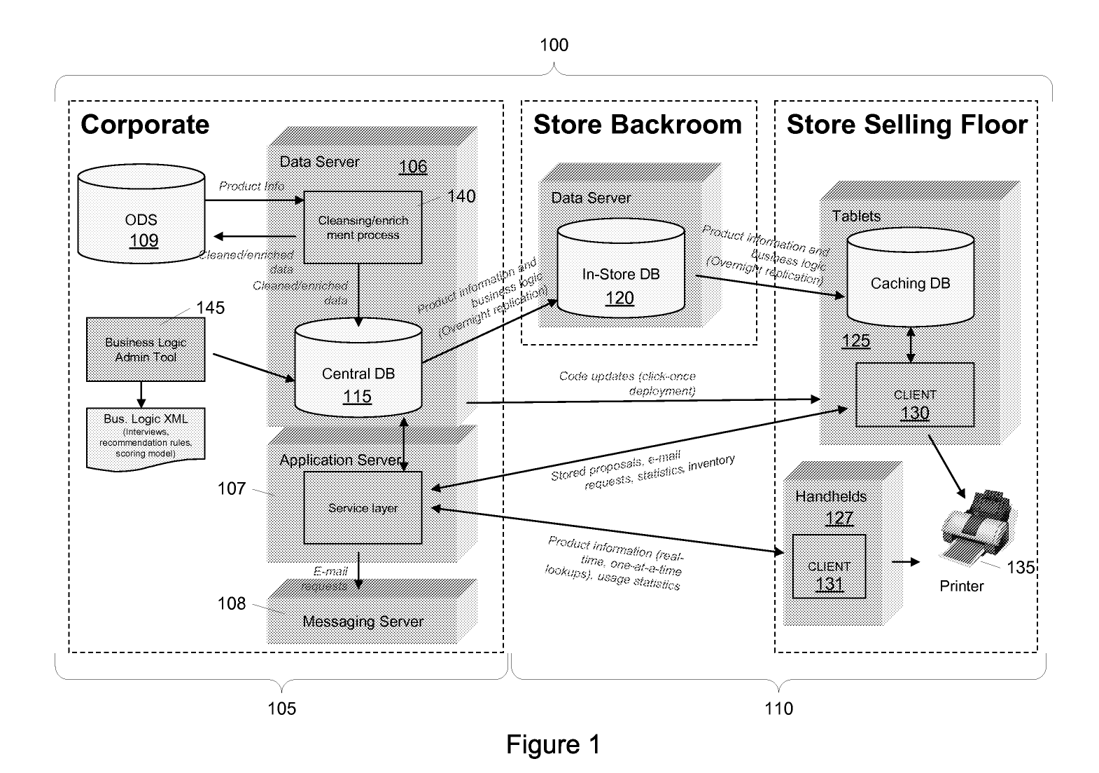

FIG. 1 illustrates a network architecture for communicating a variety of store and customer data. Network architecture 100 may be built such that various communications and data transfer processes may be conducted between a central corporate system 105 and one or more corresponding stores such as store 110. For example, store 110 may download product prices and information from corporate system 105 at predefined times through network architecture 100. Data may be reconciled between system 105 and store 110 at a predetermined frequency such as once a day. The time of day at which the data is reconciled may be preset. In one example, data may be transferred between system 105 and store 110 between midnight and 2 AM when network traffic may be at a low point. Information received from system 105 and, in particular, central database 115 of system 105, may be saved to an in-store database such as database 120. Databases 115 and 120 may each employ database server code such as SQL SERVER 2005. System 105 may include multiple servers such as data server 106 (in which database 115 may be disposed), application server 107 and electronic messaging (e.g., e-mail) server 108. Application server 107 may be used to publish applications and services to devices 125 and 127 in store 110 while messaging server 108 may be used to facilitate internal and external message transfers. Devices 125 and 127 may include a variety of computing devices including desktop, laptop and tablet personal computers (PCs), mobile communication devices such as cell phones and smart phones, personal data assistants (PDAs) and the like.

In one or more arrangements, device 125 may include a tablet PC while device 127 may include a handheld device such as a PDA. Devices 125 and 127 may include a variety of input features such as a touch-sensitive or stylus-sensitive display device, keyboard, mouse, microphones for audio input and the like. Data stored to database 120 may subsequently be distributed to one or more devices 125 and 127. In one example, tablet PC 125 may be used by a sales associate to guide potential customers to products and provide them with in-depth information regarding each item. Each of devices 125 and 127 may include client applications 130 and 131 for receiving and/or consuming information, updates and/or services (e.g., XML Web services) from a central system such as system 105. Client applications 130 and 131 may, in one or more embodiments, include .NET SmartClient and/or .NET Mobile Client software. Alternatively or additionally, client applications 130 and 131 may be used to receive and deploy code updates received from database 115. Client applications 130 and 131 may further consume and/or use services provided by application server 107. E-mail may also be sent from tablet PC 125 or handheld 127 to external and/or internal recipients through messaging server 108. According to one or more configurations, tablet PC 125 may include a caching database for locally storing product information and business logic replicated from in-store database 120. Replication may occur at predefined times such as during late night hours when network traffic is at a minimum. In contrast, handheld 127 might not include a local database and may, instead, retrieve product information in real-time through a service published by server 107. Other information that may be retrieved by devices 125 and 127 include stored consumer information, stored proposals, inventory data and sales statistics. Devices 125 and 127 may further be connected to one or more other devices such as printer 135.

Data server 106 of corporate system 105 may further include processing component 140 for cleansing and/or enriching data such as product information. For example, product information may be formatted in accordance with a predefined format, stripped of unneeded data and/or modified to include additional product information. Cleansing and enrichment processes may include verifying store data for consistency with other available information sources and/or an available store inventory. For example, data associated with products that a store does not carry may be deleted from data server 106. In another example, product information currently stored in data server 106 may be checked against information available on the web to verify consistency. Product information may be temporarily saved in operational data store (ODS) 109 while product data is being enriched and/or cleansed. Once the product information has been cleaned and/or enriched by processing component 140, the data may be saved to central database 115. Additionally or alternatively, corporate system 105 may include logic administration tools 145 that allow a system administrator to modify business logic such as recommendation rules, product scoring models, sales questions and the like. In one example, business logic may define what interviews are available, what questions to ask, what answers to accept and how to score products based on these answers. Business logic may be stored in database 115 so that logic may also be replicated to store 110.

By deploying a corporate or central system such as system 105 in the network architecture, sales session and/or solution data may be accessed through multiple channels. For example, a customer may initiate a sales solution at home through a company's website and later retrieve the sales solution in the store through a store device such as a sales person's tablet PC. The sales person may help the customer complete or further refine the solution in the store. If the customer wishes to make further refinements to the solution upon returning home, the customer may do so by accessing the solution from home. Similarly, a sales solution that is created at a first store may be accessed and continued at a second store and completed at a third store by retrieving the solution data from a central corporate system at each of the stores. Additionally, the network architecture may support the simultaneous viewing and accessing of solution information over multiple channels. In one example, a customer may be working on a sales solution at home while speaking to a customer support specialist. Thus, to help the customer with various issues, the customer support specialist may access the solution information simultaneously with the customer.

Additionally or alternatively, various security measures may be used to protect customer and store information. One security measure may include automatic deletion of sales solution or session information once the information has been uploaded to in-store database 120 and/or corporate database 115. Thus, in one example, if a sales person or technical support associate makes a house call to troubleshoot a product, information that is collected during the house call using a guided sales system deployed on a mobile computing device may be automatically deleted from the mobile device once the information is uploaded to store 110 or corporate system 105. Such a security measure may prevent an unauthorized user of the laptop from accessing customer and/or store information.

According to one or more configurations, in-store DB 120 might not be used in the network architecture. Instead, tablet device 125 may communicate directly with corporate system 105. As such, product information, business logic, inventory information and the like may be replicated between a caching database of device 125 and central database 115 of corporate system 105 without having to connect to in-store database 120. In addition, stored proposals, e-mail requests, statistics and/or inventory information may be transmitted from application server 107 to each of clients 130 and 131.

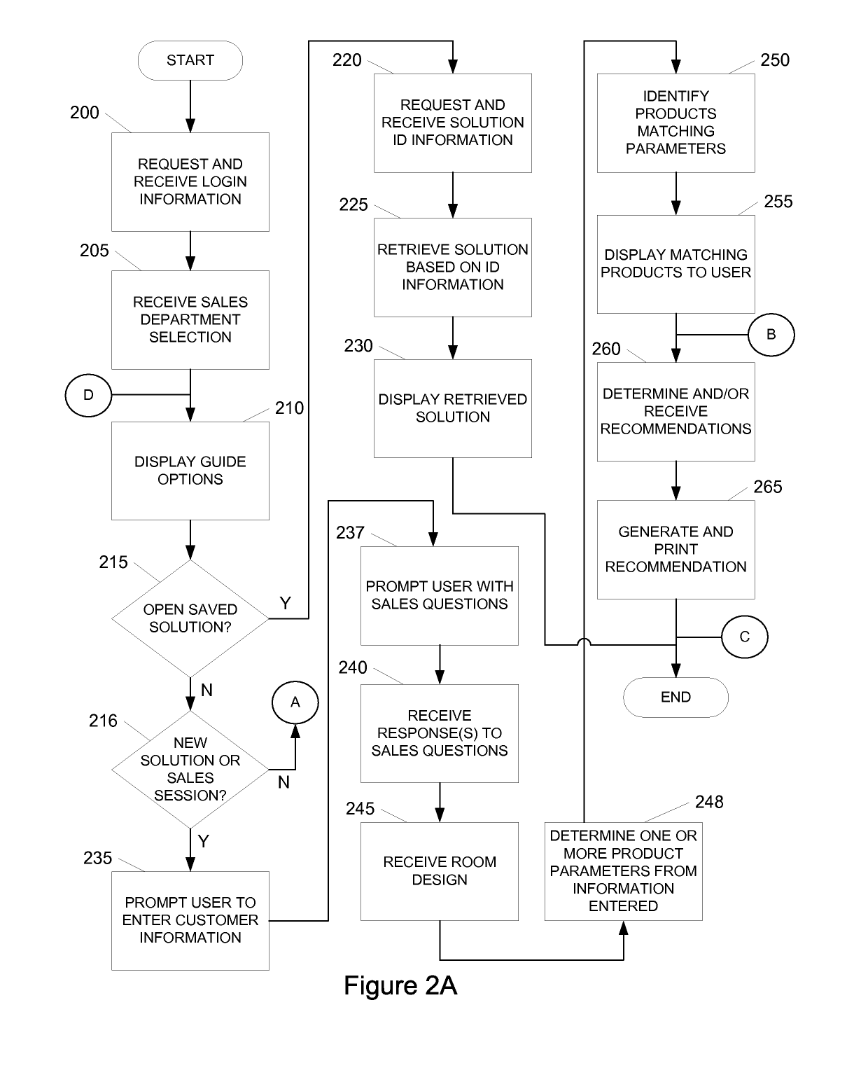

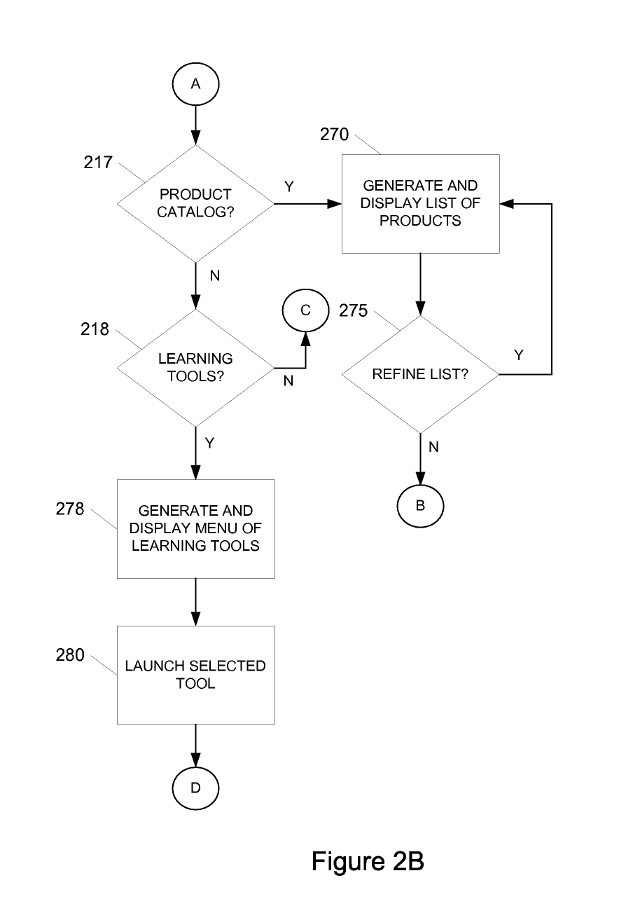

FIGS. 2A and 2B are flowcharts illustrating a method for guiding a sales associate in determining a consumer's needs and matching those needs with one or more products. In step 200 of FIG. 2A, login information may be requested from a sales associate. Login information may include a username and a password, among other security questions. Logins may be used to prevent unauthorized access and/or use of corporate information, sales data and other information. Logins may further be used to identify the sales person with which a customer is interacting. For example, an e-mail summarizing a sales solution may be sent to the customer that includes the name and/or contact information of the sales person. Upon logging in, a sales associate may select a department from a menu of sales departments in step 205. Products may be categorized in a variety of sales departments including Home Entertainment, Digital Imaging, Gaming, Car Audio/Video, Music and the like. In one or more configurations, products such as video game consoles may fall under multiple categories (e.g., Gaming and Home Entertainment). Categories may be automatically defined based on common product characteristics or manually created based on product surveys, purchase statistics and/or user preferences. Once the sales associate has identified a relevant sales department in step 205, multiple guide options may be presented to the sales associate in step 210. These guide options may include open saved solution, start new solution, browse product catalog and access learning tool. In steps 215-218, a determination may be made as to which of four options a sales associate has selected. That is, each of steps 215-218 may relate to a process for determining whether a sales associate has selected a corresponding option.

For example, if, in step 215, a determination is made that the sales associate has selected an open a saved solution option, customer and/or solution identification data may be requested and received in step 220. A solution, as used herein, refers generally to a set of information that associates a prospective customer with one or more product recommendations. For example, a solution may include customer profile data as well as product recommendation information. The customer and/or solution identification information may include a solution ID, a customer name, customer e-mail and the like. The information may then be used to retrieve the requested saved solution from a central corporate system such as system 105 of FIG. 1 in step 225. The solution data may then be presented to the sales associate in step 230. In one or more arrangements, solution information may correspond to data collected over multiple sales sessions. A sales session, as used herein, may refer to individual occasions when a solution is viewed, modified and/or otherwise accessed. Accordingly, the opened solution data may include answers to questions to which the customer previously responded, previously made recommendations and/or notes recorded by the sales associate during one or more sales sessions. Other parameters may further be used to retrieve saved solutions. For example, a sales associate may specify that he only wants to retrieve solutions generated at the sales associate's store, completed in the past 7 days, created by the sales associate and/or including a particular name. Solution data may further be identified based on a session or time at which the information was entered or collected.

If, however, it is determined in step 216 that the sales associate has selected an option to begin a new solution, the sales associate may be prompted to enter customer information such as a name, an e-mail and a telephone number in step 235. Once the customer information has been entered and/or saved, one or more questions may be provided to the sales associate for use in determining the customer's desires and needs in step 237. In one or more embodiments, questions may be a mix of common and specific questions. For example, a list of questions may include “In what room will your product be placed?” and “At what distance will you be sitting from the television?” Other sales questions may be directed to identifying products that the customer currently owns. For example, the system may prompt the sales associate with questions such as “What type of stereo system do you currently own?” and/or “Do you currently own a progressive scan DVD player?” The sales associate may ask none, one, two or all of the questions to the customer based on the sales associate's preference and expertise. In some instances, the system may specify that a response to at least one question must be entered. Answers to some questions may be required by the system in order to find matching or recommended products.

Once the sales associate has entered the customer responses to one or more asked questions in step 240, the sales associate may then enter a room design in a designer application in step 245. The room design may aid in suggesting potential product sizes. For example, a 27″ television may be adequate for a 12′×12′ room while a 55″ television may be more appropriate for a 20′×20′ room. The designer application may also be used to aid a customer in visualizing the relative size of the product to the size room and/or the placement of the product in various locations. Room data may be entered in a variety of manners including specifying dimensions, dragging and dropping pre-defined shapes and items (e.g., TVs, couches, etc.) and free-form drawings. In one example, a sales associate using a tablet PC may approximate and/or illustrate a room and objects using electronic ink. That is, the sales associate may use a finger or a stylus to draw shapes and objects on the touch-sensitive or stylus-sensitive display. This may allow a sales associate to draw non-traditional rooms, objects that are not predefined in the system and illustrate other aspects of the room that might not be provided by the system (e.g., direction of sunlight). Further, the guided sales system may determine a room size or other parameters from a free-form room drawing by determining the dimensions of the lines or shapes drawn by the sales associate and, in one or more configurations, converting them to an actual size based on a predefined scale. The sales associate may further elect to skip the designer application. In one or more arrangements, the designer application may be used to enter a free-form drawing or design corresponding to other objects or environments including cars and boats.

In step 248, one or more product parameters may be determined from the information entered. For example, a range of television sizes may be determined based on an entered room size. Products matching the one or more product parameters may be identified in step 250. In one or more configurations, a match may be defined based on a threshold level of matching information. In other words, a product may be required to match at least a certain number of parameters in order to be considered a match. The threshold level may be set by the sales associate or may be defined as a system default. Business logic may also be used to determine or define a match. The matching products may then be displayed to the sales associate and/or customer in step 255. In one or more instances, the matching products are displayed prior to any recommendations being made. The sales associate may subsequently make a manual recommendation or use an automatic recommendation tool to select one or more products from the matching products that may be particularly suited to the customer in step 260. For example, if a sales associate manually recommends a product, the guided sales system may determine or identify the recommended product based on an input location corresponding to the selection of the sales associate (e.g., tapping a touch-sensitive or stylus-sensitive screen with a stylus). Alternatively or additionally, the guided sales system may choose recommended products based on a degree of match of each product with the parameters. Steps 235-260 may be repeated for each product a customer wishes to purchase in a solution. For example, if a customer is purchasing a home theater system, a customer may want to purchase a television, speaker system, television stand, receiver and the like. Similarly, product accessories may also be presented to a customer and/or sales associate when listing product matches or making recommendations.

In step 265, the sales associate may generate and print out a recommendation that may include a sales ticket. The sales ticket may include bar codes for products selected by the customer or recommended by the sales associate to facilitate a customer's checkout process. The recommendation may further include other product or store related information such as sales associate contact information, store information and details about the recommended products. The customer may subsequently bring the recommendation and/or the sales ticket to a register and complete the purchase without having to carry all of the products to the register. In one or more arrangements, a recommendation and/or sales ticket information may be electronically transmitted to a point of sale (e.g., a store checkout register). Thus, when a customer is ready to checkout, the customer's recommendation and sales ticket may be identified by a solution ID number, the customer's name or a variety of other information. The sales associate may also perform other actions with the solution information including e-mailing the recommended/proposed solution to the customer, printing a session and/or solution summary or saving the solution to the corporate database for later retrieval and use. Alternatively or additionally, a sales ticket may be printed independently of the recommendation.

Referring to FIG. 2B, if the sales associate's selection does not correspond to either opening a saved solution or starting a new solution as determined in steps 215 and 216 of FIG. 2A, respectively, a determination may be made as to whether the selection corresponds to a product catalog option in step 217. If the selection corresponds to the product catalog option, the sales associate may be presented with a list of products available through the store in step 270. The products may be organized and/or displayed in accordance with product categories such as TVs, receivers, speakers, subwoofers and the like to reduce the amount of information a sales associate or user must digest on one page. In step 275, the system may determine whether parameters have been specified and received for refining the product list. Such parameters may include product brand, screen size for televisions and/or other displays, availability, display type (e.g., LCD, plasma, etc.), speaker wattage and the like. Product lists may be generated based on a specific store's availability or may reflect availability of one or more products throughout the company. In response to determining that new or different product parameters have been specified, the product list may be regenerated and displayed in step 270. If, however, no further refinements have been received and/or made to the product list parameters, recommendations may then be made in step 260 of FIG. 2A to the customer and a sales ticket, if desired, may be generated and printed in step 265 of FIG. 2A. Alternatively or additionally, users may view additional details of one or more products included in the list and/or compare products.

According to one or more aspects, a product list may further be refined based on location and/or inventory. For example, a user may use a location parameter to generate and view a list of products available at a specific store close to the user's home. The location parameter may further be used to refine product listings based on a specified state, city, region (e.g., northeast, mid-atlantic, northern Virginia) or other location descriptor. A user may also refine a product list based on inventory such that only products that are in inventory are listed.

If the sales associate opts for the product learning option in step 218 (FIG. 2B), a menu may be generated and presented to the sales associate identifying one or more available learning tools in step 278. Learning tools may include tools for visualizing the effects of a camera zoom lens, visualizing the differences in contrast between a plasma display and an LCD display, camera filter effects, high definition television (HDTV) resolution differences and the like. Visualization and learning tools are discussed in further detail below. Upon selecting one of the visualization or learning tools, the selected tool may be launched in step 280. The visualization and/or learning tool may, in one or more configurations, be integrated with the guided sales system and launch directly from the system rather than requiring the minimization or closure of the guided sales system before accessing the learning tool. Once the sales associate or consumer is finished using the learning tool, the sales system may return to the menu displayed in step 210 of FIG. 2A. Alternatively, the guided sales system may return to a screen that was displayed prior to or concurrently with accessing the learning tool.

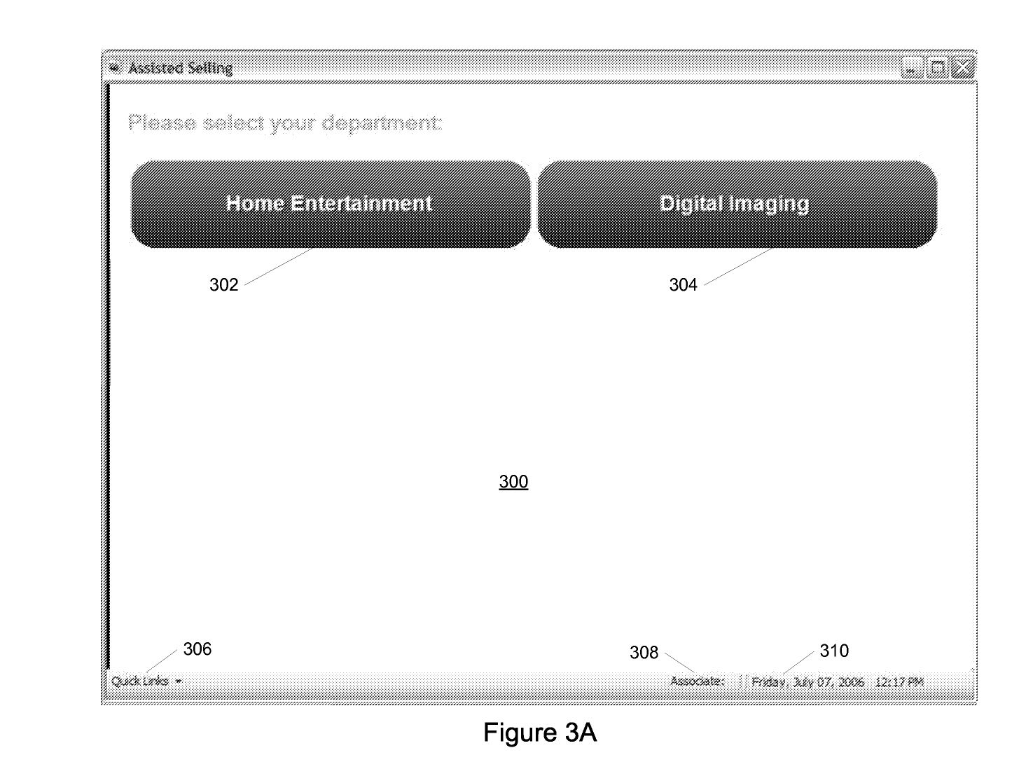

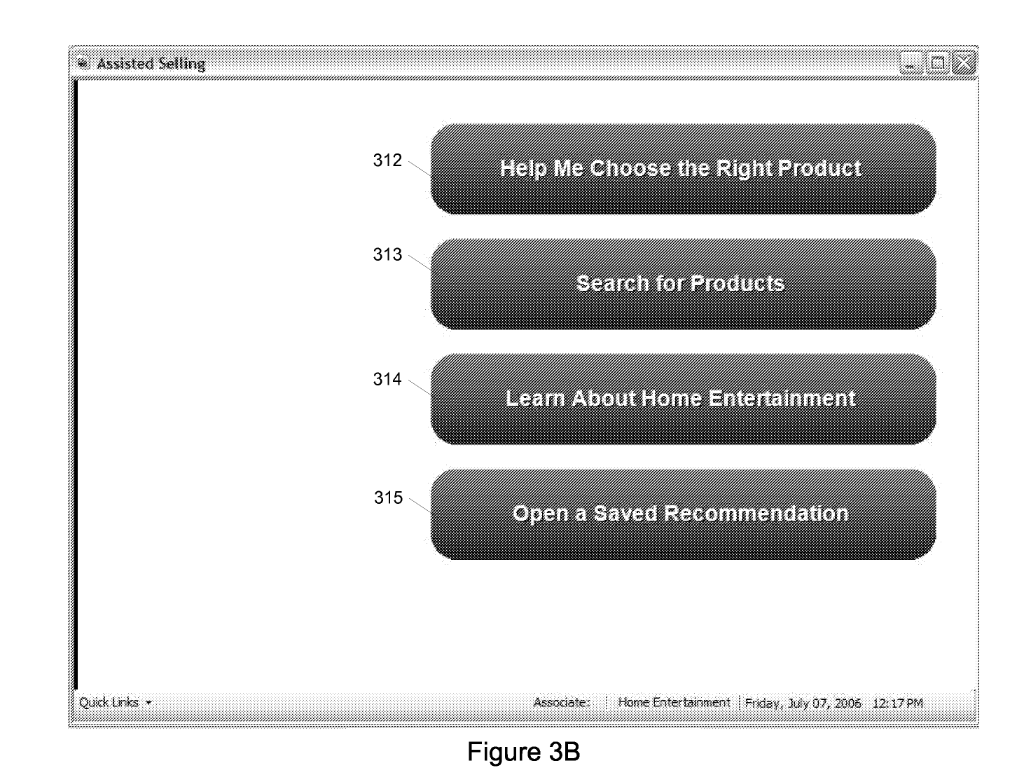

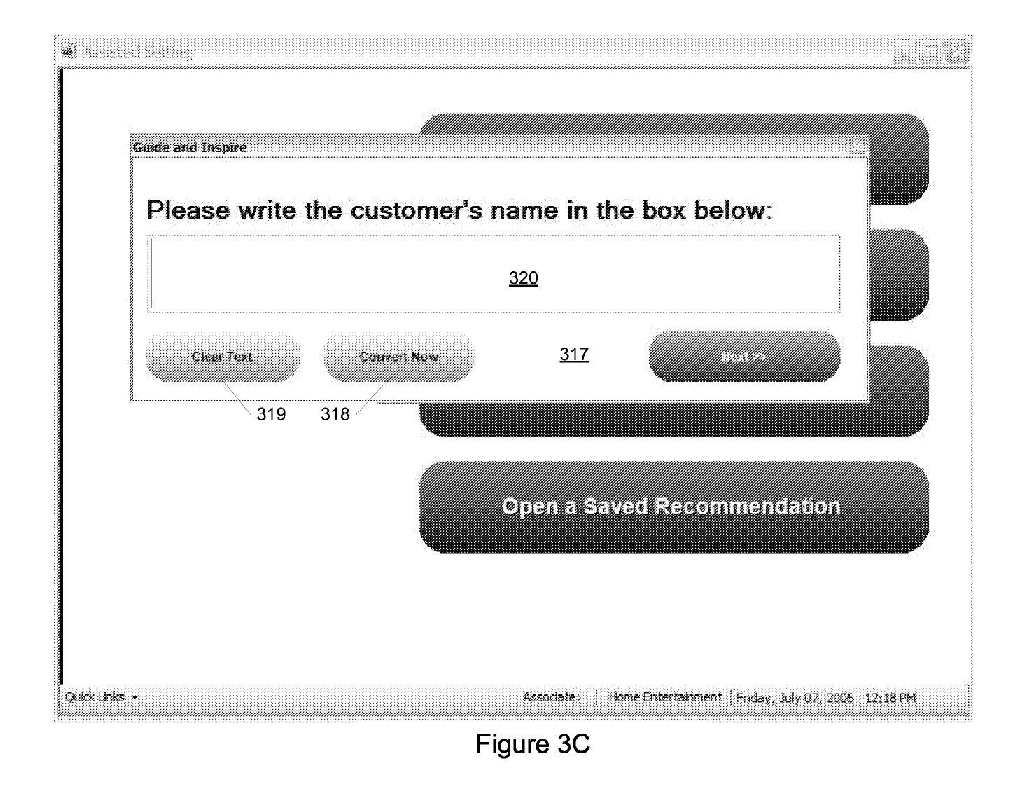

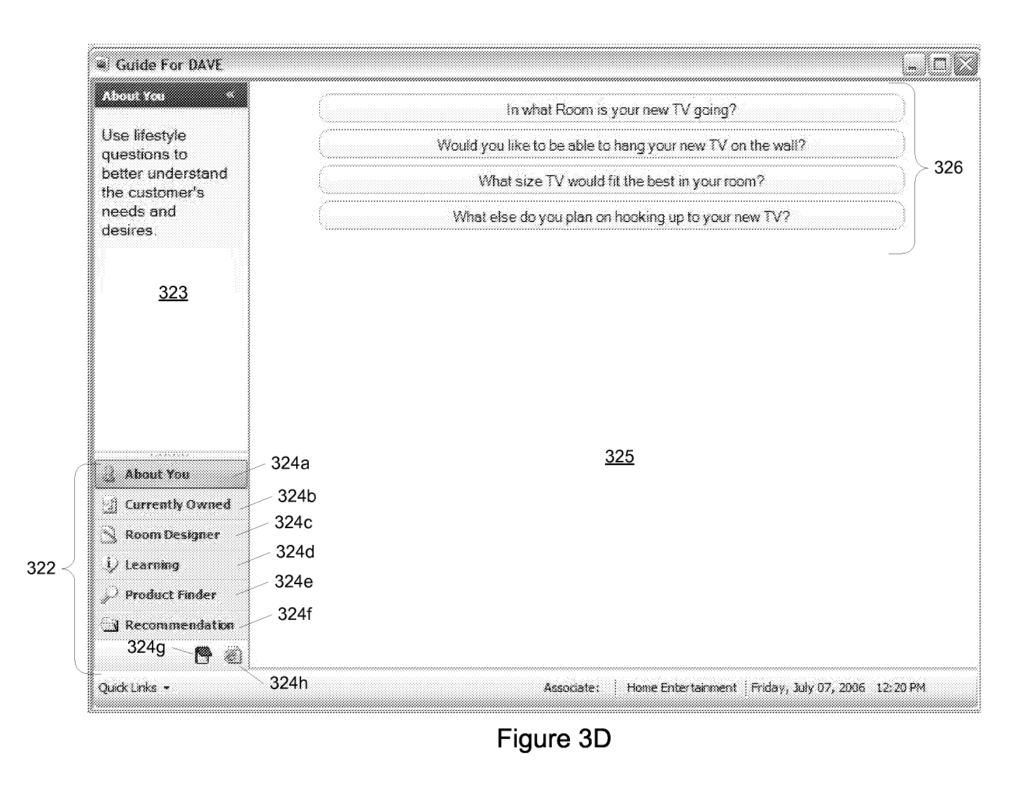

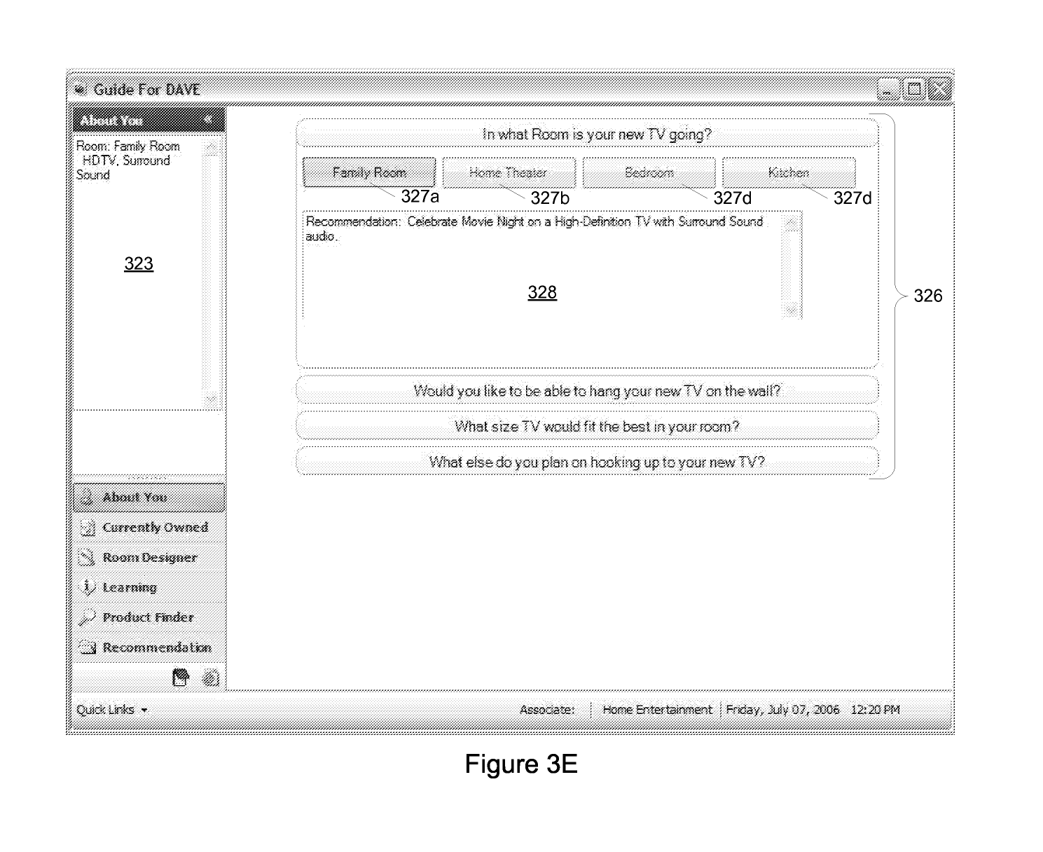

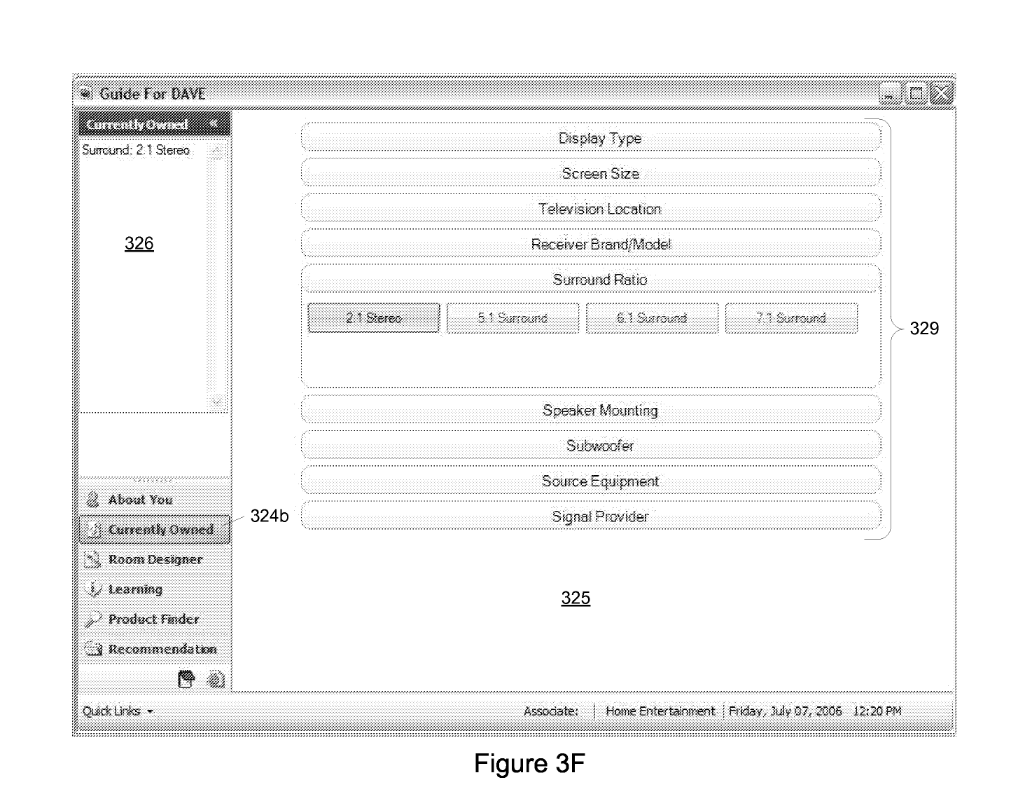

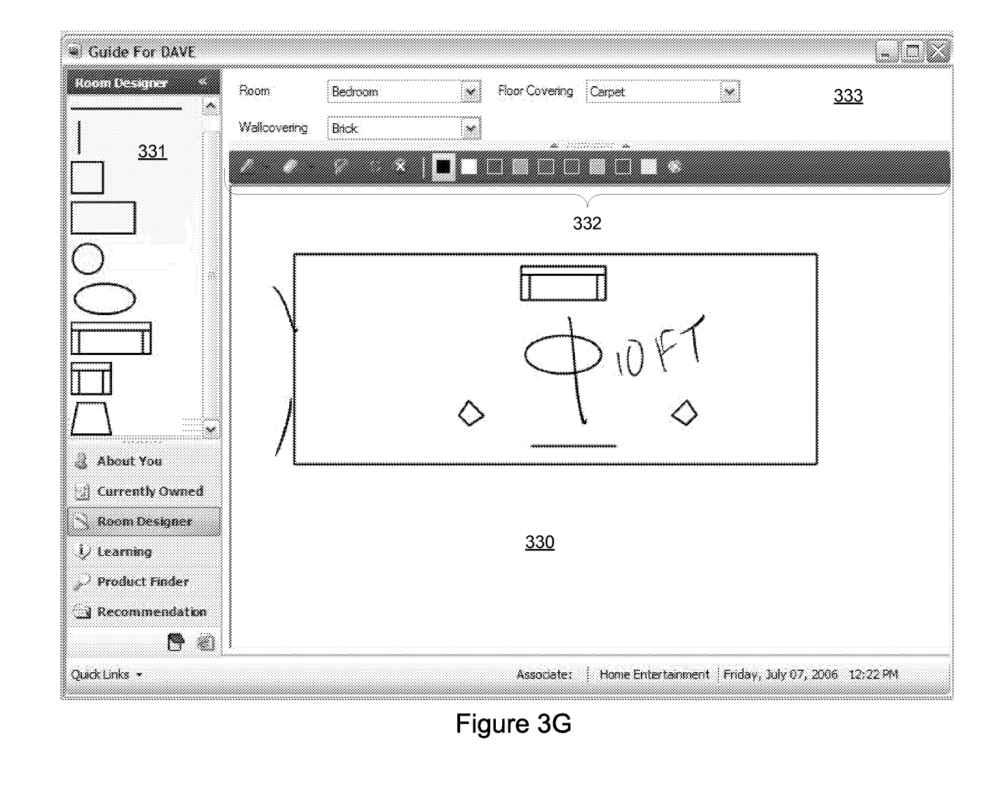

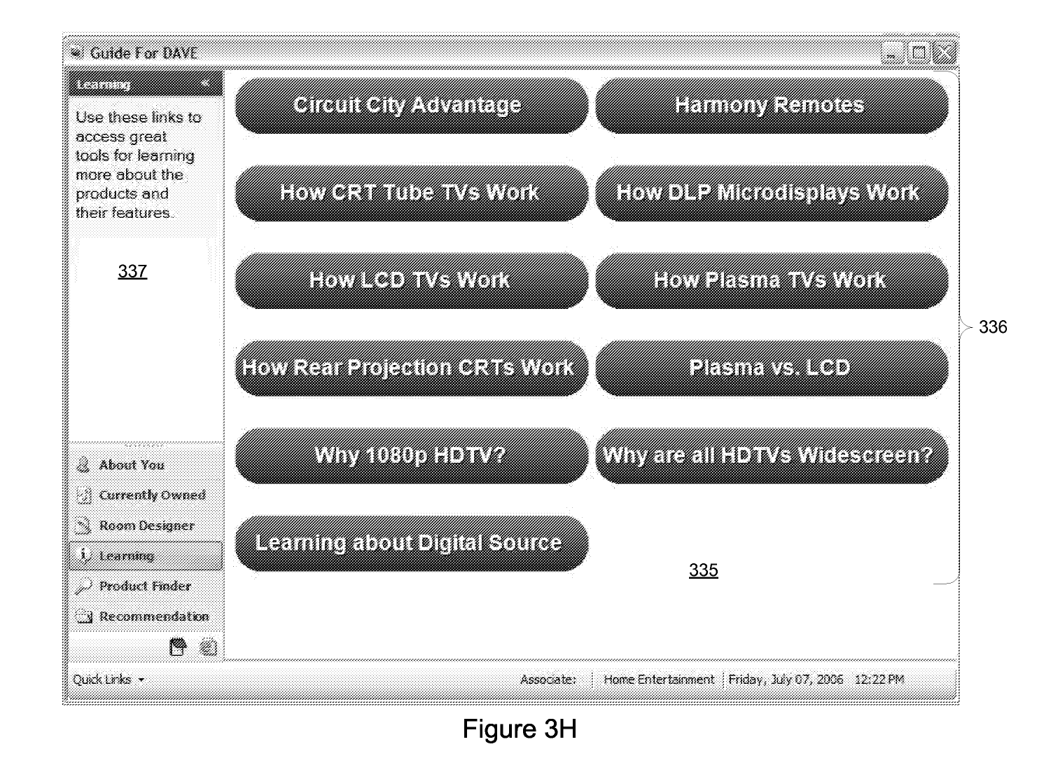

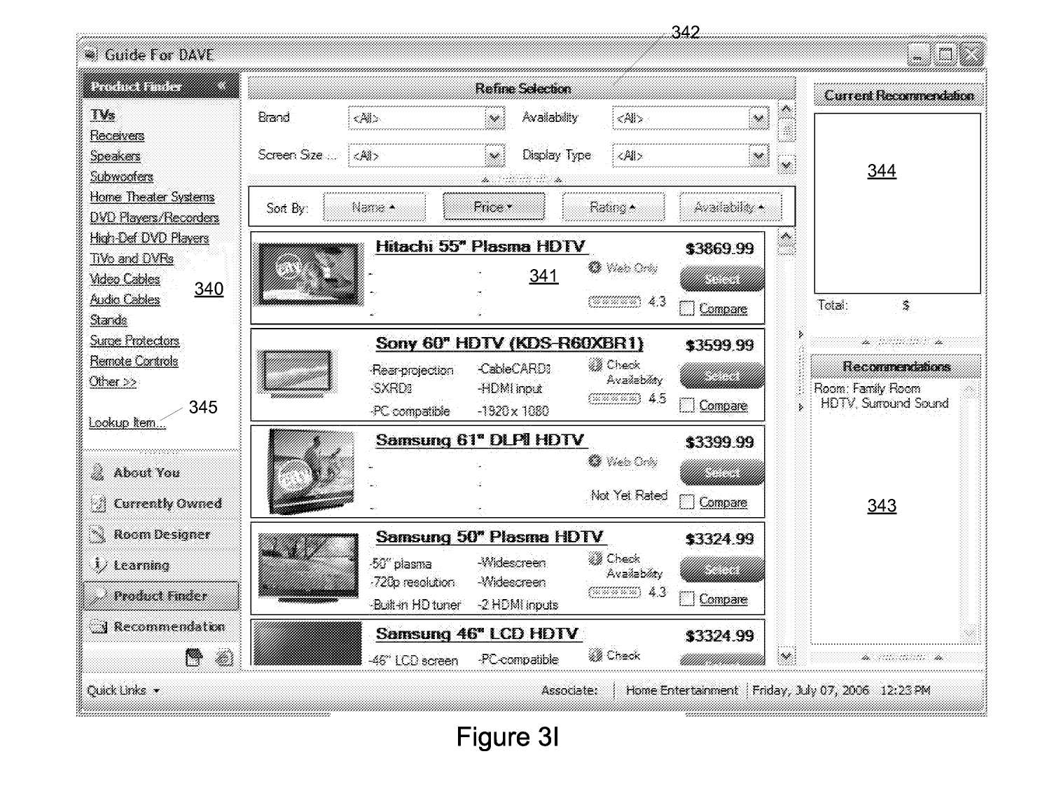

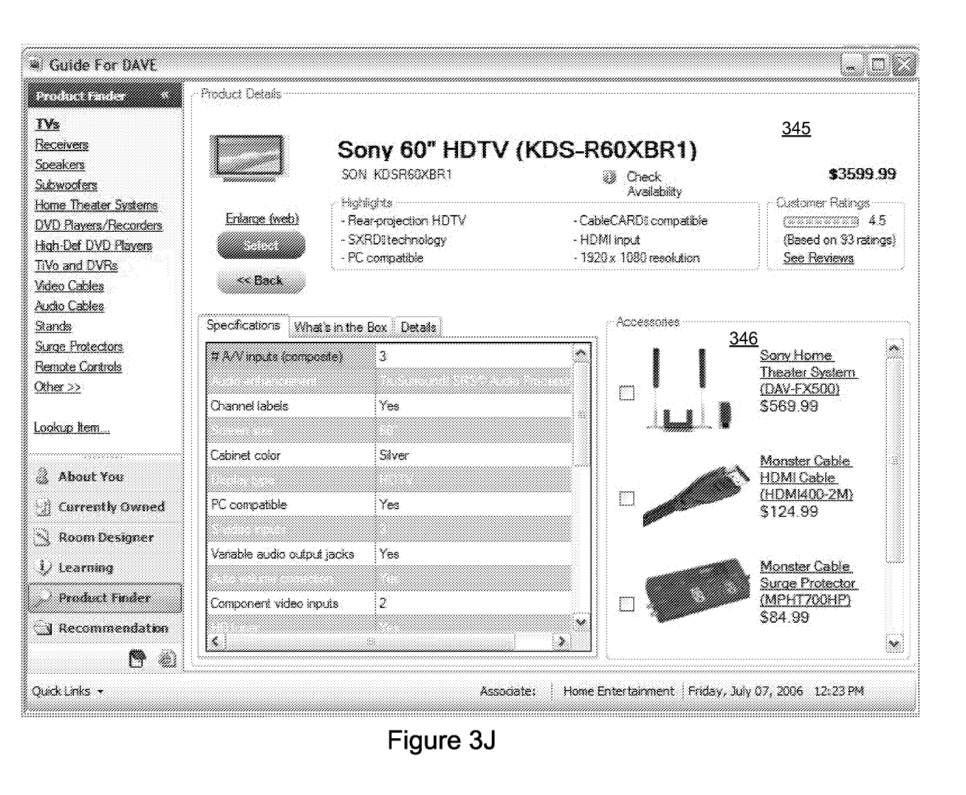

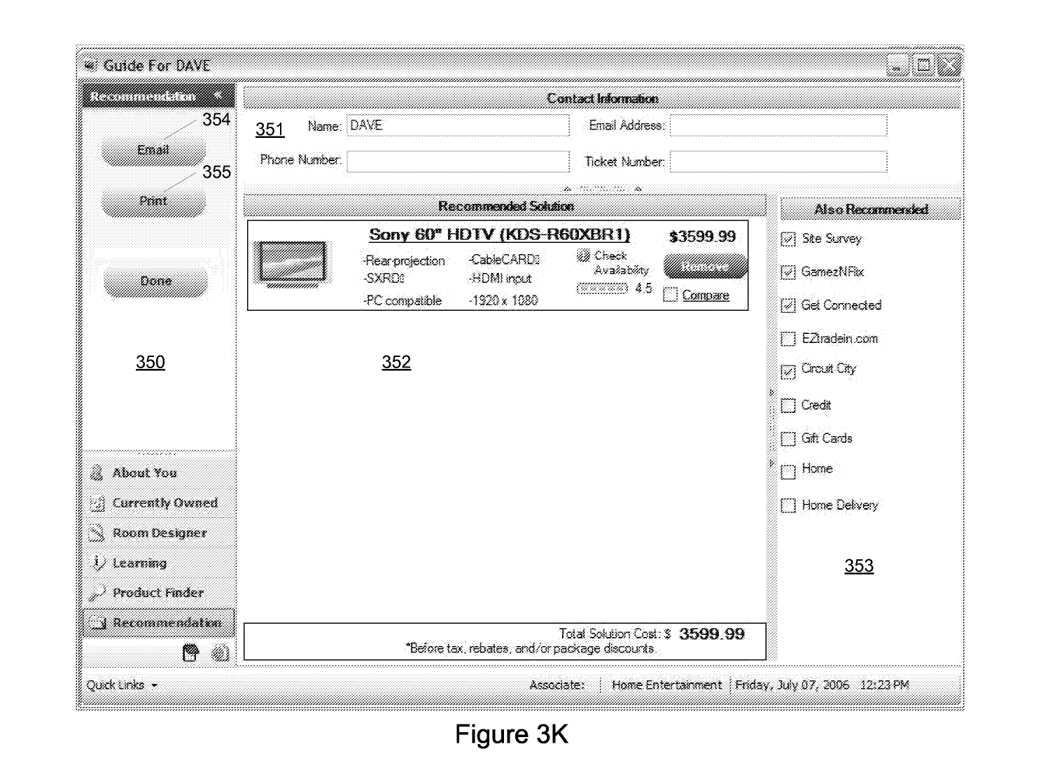

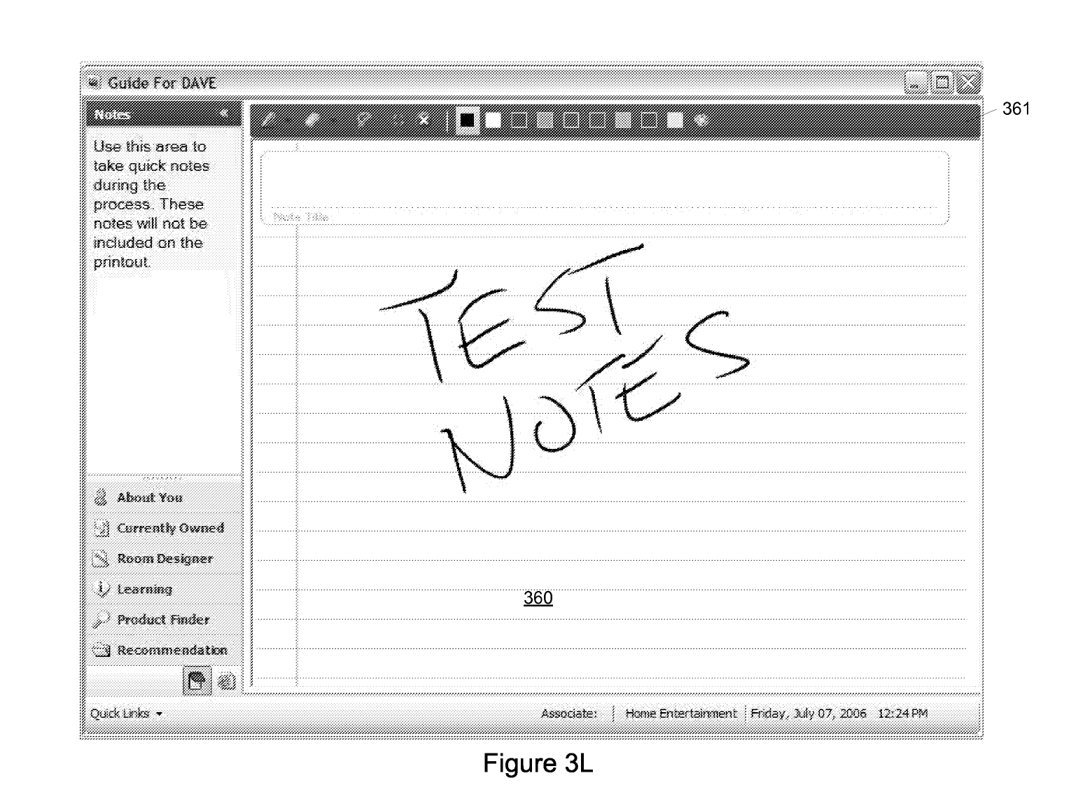

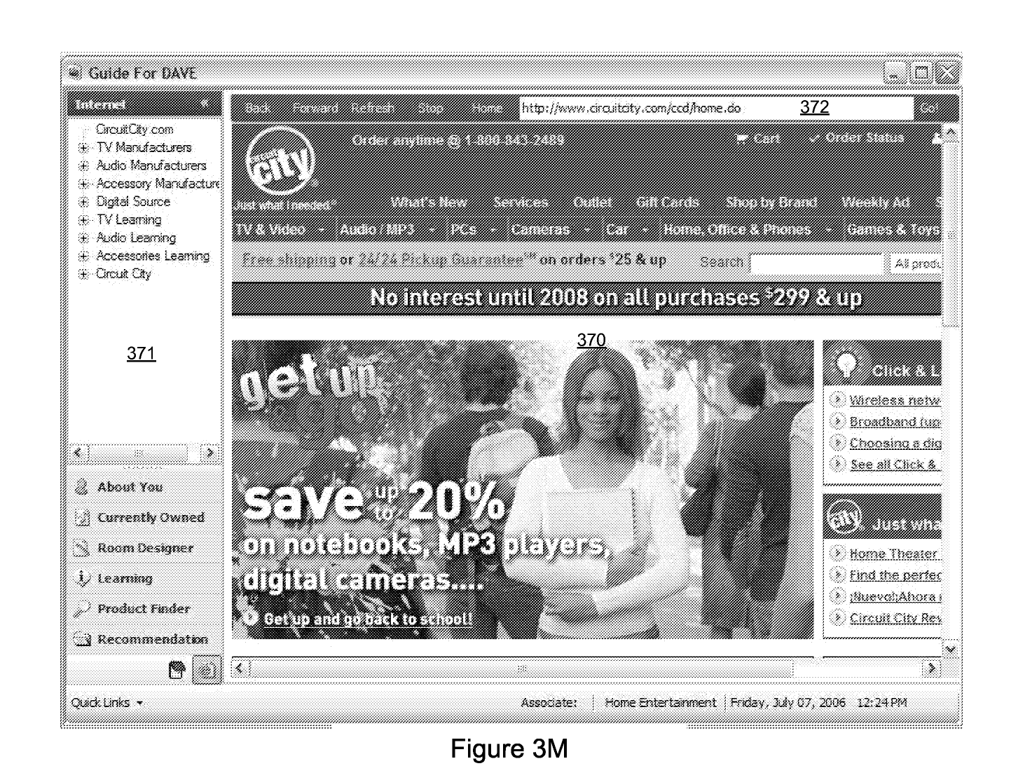

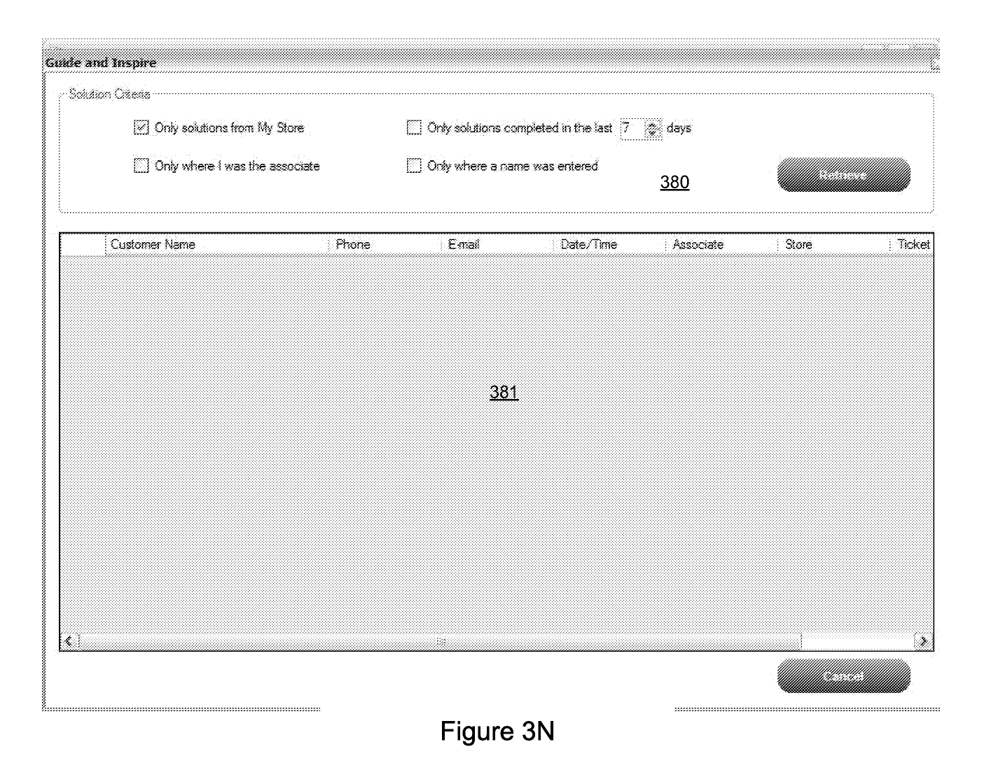

FIG. 3A illustrates a user interface for selecting a product and/or sales department in a guided sales system. Department selection screen 300 may display two options: Home Entertainment 302 and Digital Imaging 304. Department selections may be added and/or removed based on preferences and store or company organization. Additional information may be provided on screen 300 including quick links option 306, sales associate information 308 and date/time information 310. Quick links option 306 may be used to allow a sales associate or user to jump to another page or section in the sales system. For example, a sales associate may wish to navigate directly to a product finder page without having to go through the intermediate screens. While FIG. 3A illustrates options 302 and 304 as selection buttons, one of ordinary skill in the art will appreciate that a variety of selection methods may be used including radio buttons and drop down menus.

FIG. 3B illustrates a user interface displaying multiple guided sales options 312, 313, 314 and 315. For example, sales option 312 corresponds to a consumer assistance mode where the sales associate may guide a consumer in finding a suitable or appropriate product. Product search option 313 may be associated with a product listing and one or more definable and/or modifiable parameters for paring down the product list. Selecting learning option 314 may allow a sales associate or user to access one or more learning tools that aid a consumer in visualizing differences in technology and/or products. Further, option 315 may be used to open a saved recommendation or proposal that was previously saved. For example, a consumer may have come into a store a week ago, initiated a guided sales solution and had his sales session and solution information saved. Thus, upon returning a week later, the consumer's previously entered information may be retrieved without having to re-request or re-enter various pieces of information about the consumer's needs and/or desires. The information may be retrieved from a corporate database such as central database 115 of FIG. 1 or elsewhere.

FIG. 3C illustrates pop-up window 317 that may prompt a sales associate to enter a customer's name in entry space 320. Pop-up window 317 may be displayed to the sales associate or user upon selecting one of options 312, 313, 314 and 315 of FIG. 3B. In one or more embodiments, pop-up window 317 might not be displayed if, for example, the sales associate selected open a saved recommendation option 315 or product search option 313. Pop-up window 317 may further be used to collect other customer information in addition to the customer's name. Further, a user or sales associate may enter the customer's name and other information using electronic ink. Accordingly, pop-up window 317 may include convert option 318 to analyze and translate the electronic ink into computer recognizable characters. Clear option 319 may also be provided so that a sales associate may clear entry space 320 in various circumstances.

FIGS. 3D and 3E illustrate a guided sales user interface at different stages in a guided sales process. Generally, the interface may include navigation panel 322 and information panel 325. In FIG. 3D, navigation panel 322 may include a variety of interface components such as a data log 323 and navigation options 324. Each of navigation options 324 may be used by a sales associate to navigate to or access other functions provided in the guided sales system. For example, a sales associate may jump from the guided sales interface to a learning tools interface by selecting learning option 324d. Similarly, if a sales associate wants to view a listing of products, he or she may select product finder option 324e. When selecting an option from navigation options 324, the information panel 325 may update or change to display content associated with the option selected from options 324. Alternatively or additionally, selecting a new option may cause a new window or panel to be created containing the information and content associated with the new option. Navigation options 324 may further include notebook option 324g and web browser option 324h. Each of options 324g and 324h will be discussed in further detail below. In a sales guide mode, information panel 325 may display one or more questions 326 that may be used to help a customer determine suitable products. A sales associate, when showing products to a customer, may use the questions to identify relevant products.

FIG. 3E illustrates a second stage of the user interface where one or more questions 326 have been entered by the sales associate or user. For example, a customer may indicate that the television he is looking to purchase is for the family room. Upon selecting Family Room response 327a, a recommendation may appear in information box 328 directly below responses 327. Additionally, information that has been collected from the customer, such as the intended room, may be logged in data log 323. This may allow a sales associate to remember information about the customer while guiding the customer to various products or making recommendations.

When selecting currently owned option 324b, information panel 325 may display a list of product parameters 329 to identify a product that the customer currently owns, as is illustrated in FIG. 3F. Product parameters 329 may include a display type, screen size, television location, receiver brand/model, surround ratio and the like. Data log 326 may track products the customer currently owns or characteristics thereof for future reference. For example, upon entering that the customer owns a stereo system, data log 326 may be populated with sound system information. In one or more arrangements, data log 326 may include separate logs for each set of information. For example, data log 326 may store and display currently owned data separately from information about the customer (e.g., desired usage room).

FIG. 3G illustrates a room designer application or feature of the guided sales system. The room designer includes drawing area 330, shape selection bar 331, color and tool bar 332 and room description controls 333. As discussed, in one or more configurations, the design application may receive stylus or finger input from a sales associate in drawing area 330. The input may then be rendered as electronic ink resulting in a free-form drawing. Free-form drawings allow a sales associate to illustrate features and shapes that might not otherwise be available in the guided sales system. Outside of drawing area 330, the stylus and/or finger input may correspond to selection and/or control commands. For example, in shape selection bar 331, a sales associate may use a stylus to select and drag a square object into drawing area 330. Alternatively, the sales associate may choose a different wall covering from a drop down menu in room description controls 333.

FIG. 3H illustrates a user interface for selecting one or more learning tools associated with and/or integrated to the guided sales system. Learning tool selection menu 335 may display one or more learning and/or visualization tools 336. Information bar 337 may display general information about learning tools or may display information related to specific tools. For example, in response to a sales associate hovering over a particular tool in menu 335 with a cursor or other pointing device, information bar 337 may display explanatory and/or detailed information about the particular tool.

FIG. 3I illustrates a product listing user interface for browsing a list of one or more products. The user interface may include product category selection portion 340, product listing portion 341, refinement controls 342, product parameter portion 343 and recommendation portion 344. Product category selection portion 340 may include multiple product categories such as TVs, receivers, speakers, subwoofers, home theater systems, DVD player/recorders among others. Product category selection portion 340 may further include a lookup item option 345 that may allow a user to select a product using a product identification code such as a bar code or model number. Selecting a category in the product category selection portion 340 of the user interface may cause product listing portion 341 to display a corresponding list of products. The product listing in portion 341 may further be refined using refinement controls 342 to specify various product parameters such as brand, screen size, availability and display type. Product parameter portion 343 may display information that a sales associate entered based on user responses to one or more questions. For example, parameter portion 343 may include an intended usage of the product (e.g., home theater), a room in which the product will be used (e.g., family room) and technology needs or requirements (e.g., HDTV). Recommendation portion 344 may be used to display product recommendations suggested by the system or manually selected by the sales associate. In one or more configurations, products may also be dropped and dragged from product listing portion 341 to recommendation portion 344.

Alternatively or additionally, refinement controls 342 may include a location control (not shown) that allows a user to specify a particular store, city, state and/or region for which to generate the product list. In one example, a user may refine the product list to display only those products available at a particular store. In another example, a user may refine the product list to display those products available in stores located in a particular city or region. Refinement controls 342 may further include an inventory parameter (not shown) that provides a user with controls to refine a product list based on an available inventory (e.g., in inventory, not in inventory, specified number in inventory).

Selecting a product in a product listing such as the listing illustrated in portion 341 of FIG. 3I may bring up a product details screen 345 as illustrated in FIG. 3J. Product details screen 345 may display product specific information such as product specifications, accessories, items included with the product package, product highlights, price information, customer ratings and/or reviews and the like. Accessories that are compatible with the selected product may, in one or more instances, be displayed in frame 346.

FIG. 3K illustrates a recommendations user interface including action frame 350, contact information section 351, recommended solutions portion 352 and additional recommendation section 353. Action frame 350 may include options such as e-mail 354 and print 355. E-mail option 354 may be used to e-mail the recommendation solution information to one or more individuals while print option 355 may be used to print a sales ticket or general information sheet associated with the recommended products and solution. Contact information section 351 may display information about the customer such as name, e-mail address, phone number and/or ticket number. Further, additional recommendations section 353 may display additional services and/or products that the sales associate either recommends or about which the customer wishes to receive more information.

FIG. 3L illustrates a note entry user interface including notepad section 360. Notepad portion 360 may be used to enter notes using various input devices such as keyboard, mice, stylus and/or a user's fingers. A stylus and/or a user's finger may be used to enter handwritten notes. These handwritten notes may later be converted to computer recognized characters for additional processing. Toolbar 361 may be included to allow a sales associate to change the writing color, to erase information, cut and paste and the like. The notes may be saved for later use or reference by the sales associate. In one or more configurations, the notes may be stored in association with a particular sales session and/or the general sales solution.

FIG. 3M illustrates a web browser feature including browser frame 370 and links toolbar 371. Browser frame 370 displays the web content while links toolbar 371 may display and provide shortcuts to frequently visited websites and/or favorite websites. The windows in the web browser user interface may be resized to, for example, enlarge browser frame 370. Address bar 372 may further be included in browser frame 370 to permit a sales associate or user to enter a particular uniform resource locator (URL). A sales associate or customer may use the web browser feature to retrieve additional information about a product that might not otherwise be available through the store or corporate database.

FIG. 3N illustrates a solution retrieval interface for locating and opening previously saved solutions. The interface may include search parameter section 380 and a solution listing section 381. Search parameter section 380 may allow a sales associate to specify a time frame associated with a desired solution, to limit the solution listing to those solutions where the sales associate was involved, where the customer's name was entered and/or where the solutions were created in the current store. Based on the search parameters, solution listing section 381 may be populated with matching solutions. The sales associate may then select a particular solution or refine the search. Solution listing section 381 may provide a variety of information for each matching saved solution including customer name, phone, e-mail, date/time, associate, store and/or ticket ID.

As discussed, multiple learning and visualization tools may be used with and/or integrated in one or more configurations of a guided sales system. These tools may include a resolution visualization tool, a filter effect tool, a zoom visualization tool, a megapixel differentiation tool and ambient light effect tool. Each of these tools is aimed at providing a customer with a way to visualize and/or experience the differences in technology and products. Part of the learning and visualization experience may include audio overlays to provide narration or other audio content (e.g., music). Learning tools may correspond to particular guided sales questions or guided sales options. For example, a sales question regarding preferred television technology may be tied to a learning tool for visualizing differences between LCD televisions and plasma televisions.

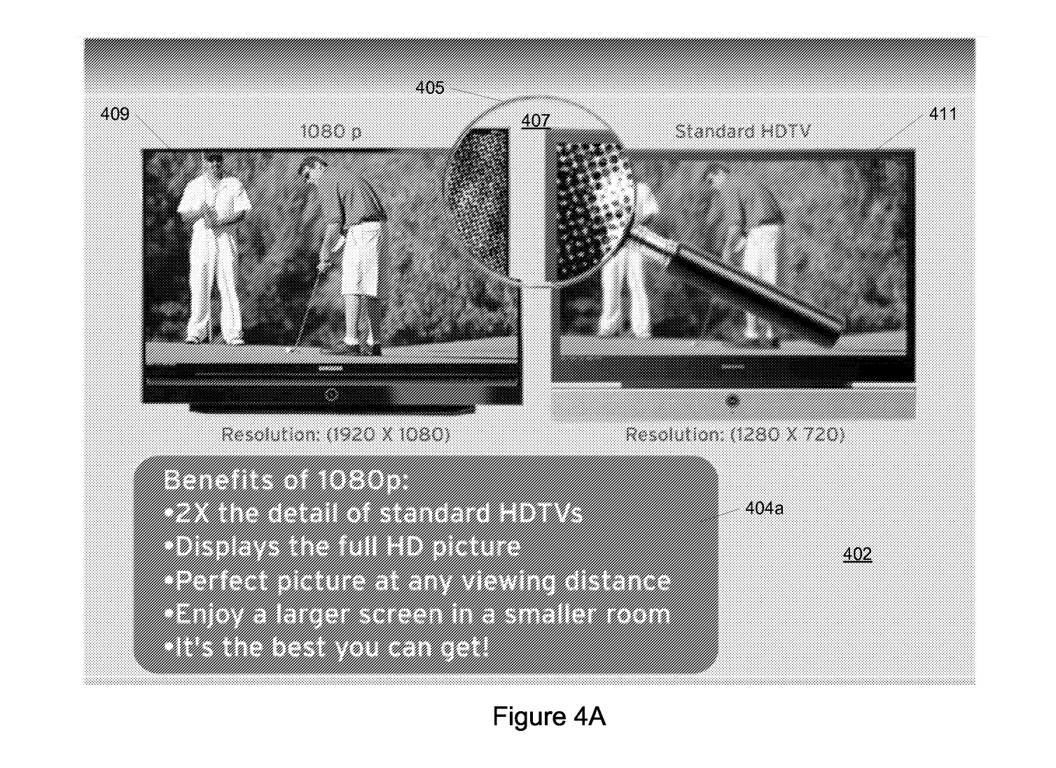

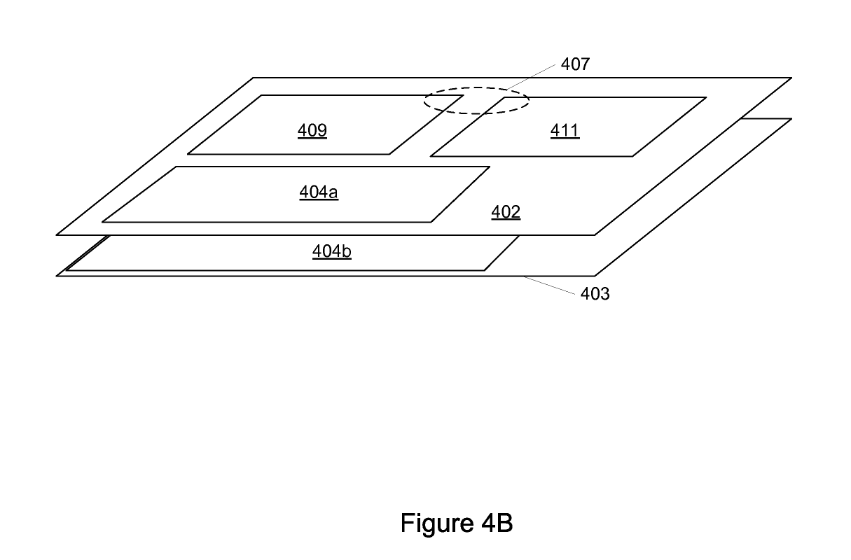

FIG. 4A illustrates a screen resolution tool that allows a customer to view the differences in pixelation associated with a first resolution (e.g., 1080 p)versus a second resolution (e.g., 720 p). The screen resolution tool may include top layer 402 and a bottom layer (not shown) beneath top layer 402. Top layer 402 may represent a non-magnified view of the tool interface while the bottom layer may reflect a magnified view of the interface. Top layer 402 may include images 409 and 411 and text associated with product details 404a. A magnifying glass tool 405 may be actuated to allow a sales associate or user to specify magnification of a particular area such as area 407. Magnifying glass tool 405 may be guided around the interface using various input devices such as a keyboard (e.g., arrow keys), a mouse, a stylus or a user's finger. In one or more embodiments, magnifying glass tool 405 may track the movements of a stylus or user's finger on a touch-sensitive display surface (not shown). As a user moves magnification area 407 around images 409 and 411, a magnified and pixelated version of the image may be displayed in area 407. The portions of the interface outside of area 407 may remain in an unmagnified and unpixelated state. Accordingly, moving tool 405 and area 407 from one simulated television image, e.g., image 409, to another, e.g., image 411, may illustrate differences in pixelation associated with different screen resolutions. A variety of other shapes and tools may be used in place of or in addition to magnifying glass tool 405 and magnification area 407.

FIG. 4B illustrates a layer configuration for producing the magnification and pixelation effect illustrated in FIG. 4A. A magnification tool such as tool 405 of FIG. 4A may be configured such that top layer 402 representing an unmagnified version of the interface overlays a second layer such as layer 403 that represents a magnified interface. In normal viewing, the images and objects, e.g., 404b, of layer 403 would not be visible due to the overlaying of layer 402. To provide the magnification effect, a transparency within viewing area 407 may be increased such that the images and objects, e.g., magnified versions of images 409 and 411 (not shown), may be visible through layer 402. The transparency of the area outside of viewing area 407 may be maintained such that the remainder of layer 402 is still visible (and the remainder of layer 403 is hidden). Layers 402 and 403 may be arranged such that the location, position and/or orientation of various images and objects within layers 402 and 403 correspond. For example, product and/or technology detail text 404a and 404b may be located in the same general location within each of layers 402 and 403 (i.e., lower left quadrant of each layer).

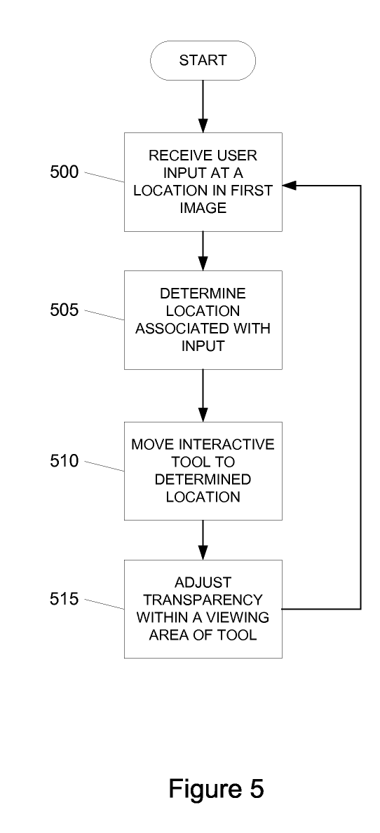

FIG. 5 is a flowchart illustrating a method for magnifying a portion of an image. In step 500, user input is received corresponding to a location within a first image. The user's input may be received through a variety of input devices including a stylus and a user's finger. The location corresponding to the user's input is determined in step 505. In step 510, an interactive tool (e.g., magnifying glass tool 405 of FIG. 4A) may be moved to the location determined in step 505. For example, a center point of the interactive tool may be moved to the determined location. In step 515, a transparency within a viewing area of the interactive tool (e.g., magnification area 406 of FIG. 4A) may be increased while maintaining the transparency levels of the area outside of the viewing area. The transparency may be increased such that a second image underlying the first image is visible. Alternatively or additionally, the viewing area of the interactive tool may transition between the first image and the second image using various fading and transparency image processing algorithms.

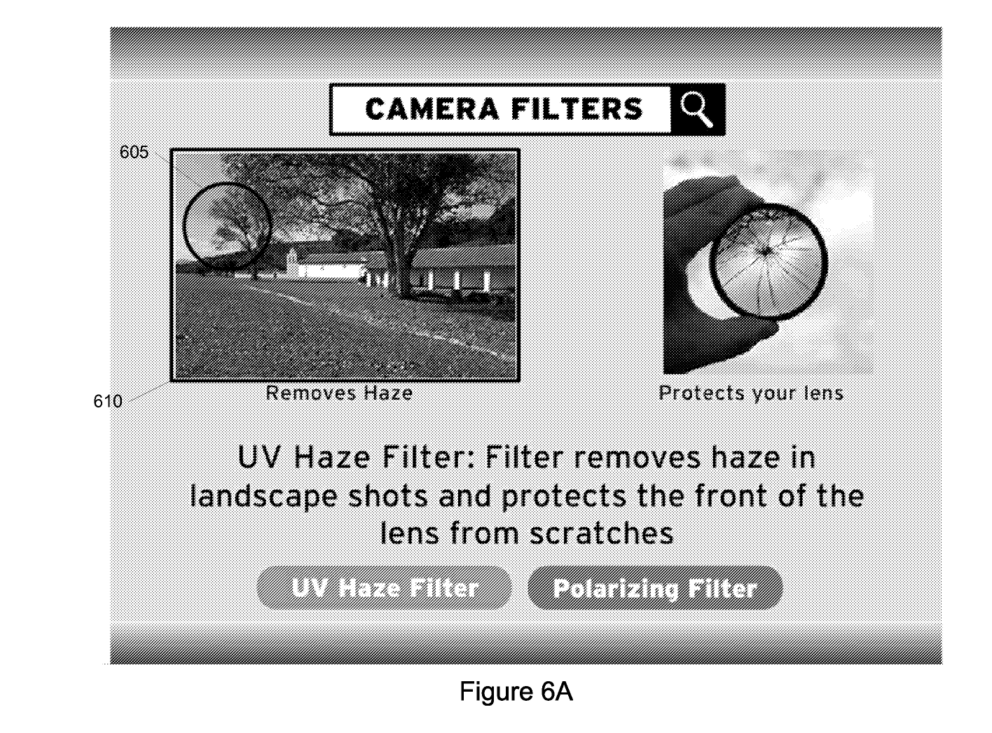

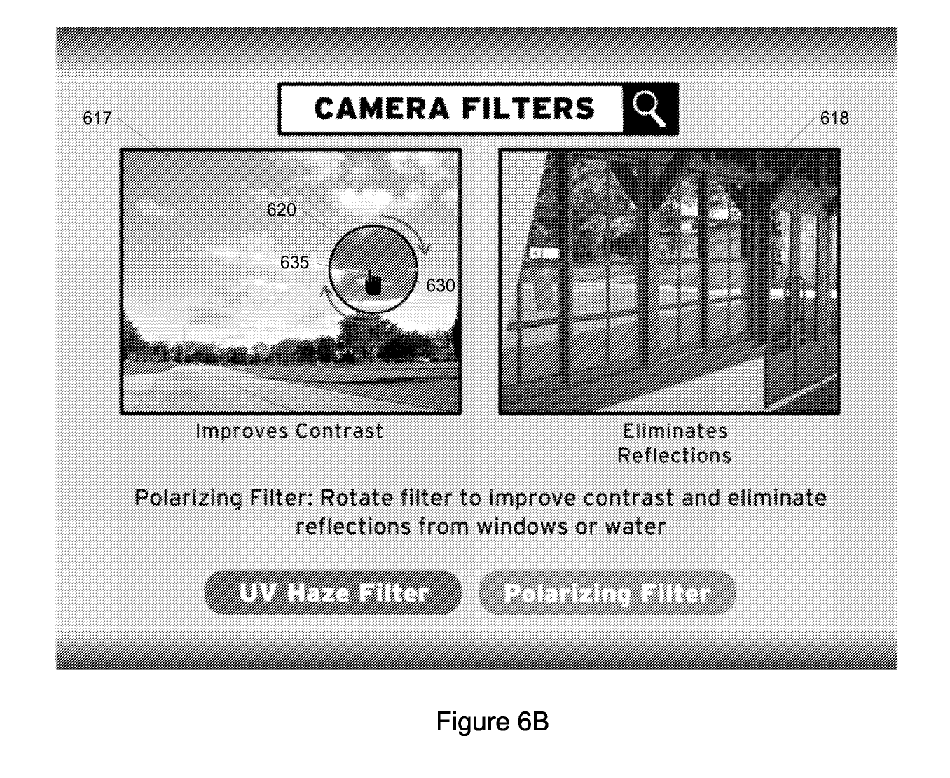

FIGS. 6A and 6B illustrate two filter effect tools for allowing a viewer to visualize the effects of various camera filters. For example, FIG. 6A illustrates ultra-violet (UV) haze filter 605 and a simulated image or photograph 610. As filter 605 is moved over image 610, the image within filter 605 provides a simulated filtered image. Such a visualization tool may include an original image and a filtered image. As filter 605 is moved around the original image, the area within filter 605 displays the corresponding portion of the filtered image rather than the original image. In one example, the original image may overlay the filtered image and by modifying the transparency of the viewing area within filter 605, the filtered image may be exposed while hiding the filtered image outside of the viewing area of filter 605.

FIG. 6B illustrates a polarizing filter tool including two non-filtered images 617 and 618 and filter tool 620. Polarizing filter tool 620 may act similarly to filter 605 of FIG. 6A in that filter tool 620 provides a filtered image within a viewing area thereof. In one or more configurations, filter tool 620 may increase the transparency within its viewing area such that a filtered image is exposed from under non-filtered image 617 or 618. The transparency might only be increased within the viewing area. That is, the transparency outside of the viewing area of filter tool 620 may be maintained such that the filtered image remains hidden outside of the viewing area. Additionally, filter tool 620 may include polarization controls that allow a user to control the degree of polarization within the viewing area of filter tool 620. In one or more arrangements, the polarization controls may include control tab 630 that indicates a degree of polarization currently in effect based on control tab 630's position on filter tool 620's border. Thus, degrees of polarization (e.g., 0° to 360°) may be mapped to positions/locations along tool 620's edge or border. A user may further move tab 630 to a second position on tool 620's border to modify the degree of polarization.

Alternatively or additionally, to activate the polarization modification functionality, a user may be required to select filter tool 620 by clicking on tool 620. Once the user selects or clicks on tool 620, tool 620 may enter an adjustment mode and an adjustment cursor 635 may be displayed allowing a user to modify the position of tab 630 and thus, the degree of polarization. Upon moving adjustment cursor 635 outside of tool 620, tool 620 may revert to a viewing mode whereby tool 620 tracks the movements of the user's input. A modification to the degree of polarization may be reflected by adjusting the transparency of tool 620's viewing area. Accordingly, a range of transparency levels may be mapped to the range of defined and selectable positions/locations along tool 620's border.

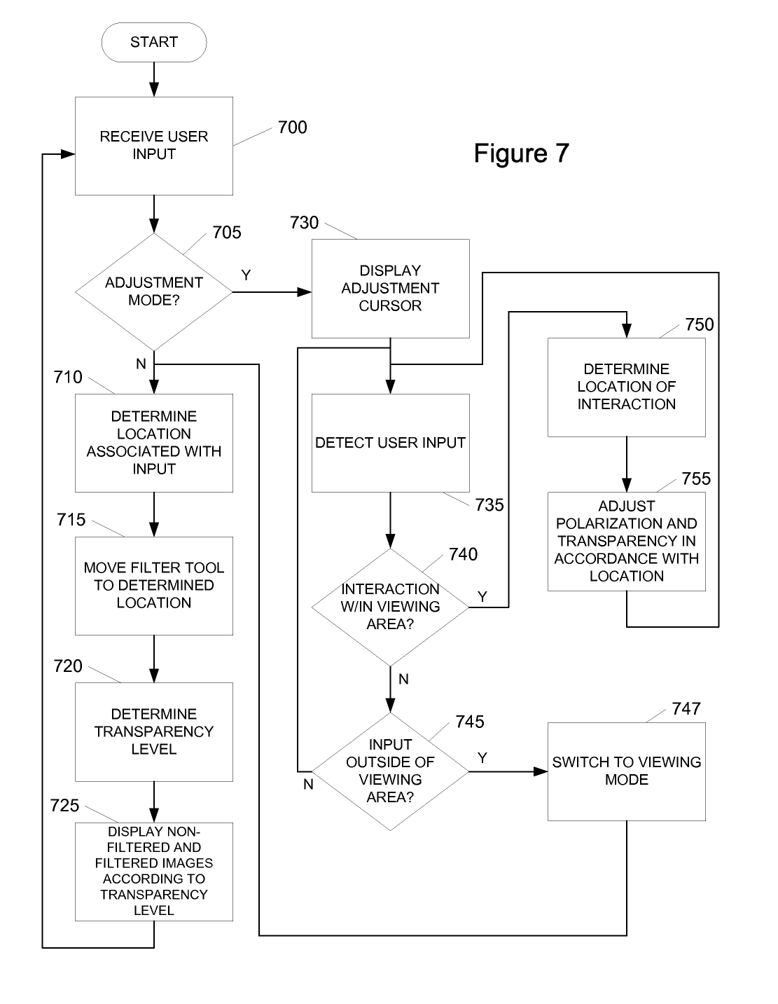

FIG. 7 is a flowchart illustrating a method for simulating the effects of a filter. In step 700, user input may be received through an input device such as a mouse, keyboard and/or touch-sensitive display. A determination may be made in step 705 as to whether the input corresponds to activation of a polarization adjustment mode. The system may predefine input as corresponding to the adjustment mode. For example, clicking inside the filter tool may constitute activation of the adjustment mode. If, in step 705, it is determined that the input does not correspond to activation of an adjustment mode, a location associated with the input may be determined in step 710. In step 715, a filter icon or tool may be moved to the location of the input. That is, in steps 700-715, the filter icon or tool may track the movement of the user's input. In step 720, a current transparency level may be determined based on a current setting of the filter tool or a default setting. Subsequently, in step 725, the viewing area within the filter tool may display the non-filtered image and the filtered image in accordance with the determined level of transparency. For example, if the settings of the filter tool correspond to 100% transparency, the viewing area may set the non-filtered image as completely transparent, and only display the filtered image.

If, however, a determination is made in step 705 that the input does correspond to activation of an adjustment mode, an adjustment cursor may be displayed in step 730. In one or more arrangements, the adjustment cursor may be displayed as an indicator that the filter tool is in an adjustment mode. In step 735, user input may be detected. A determination may then be made in steps 740 and 745 as to whether the input corresponds to movement outside of the viewing area or selection of a location within the viewing area, respectively. If it is determined that the input corresponds to movement outside of the viewing area, the filter tool may be returned to a viewing mode in step 747 and operate according to steps 710-725. If, however, it is determined that the input corresponds to a selection within the viewing area, a location of the selection and a corresponding polarization and/or transparency level may be determined in steps 750 and 755, respectively. The filter tool and system may then return to step 735.

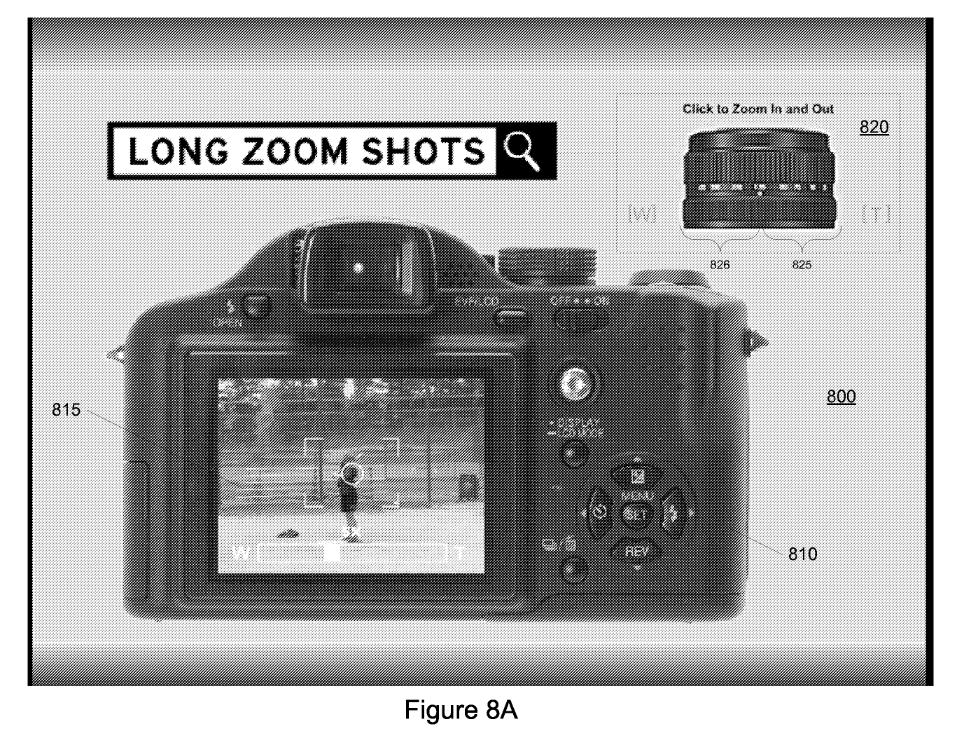

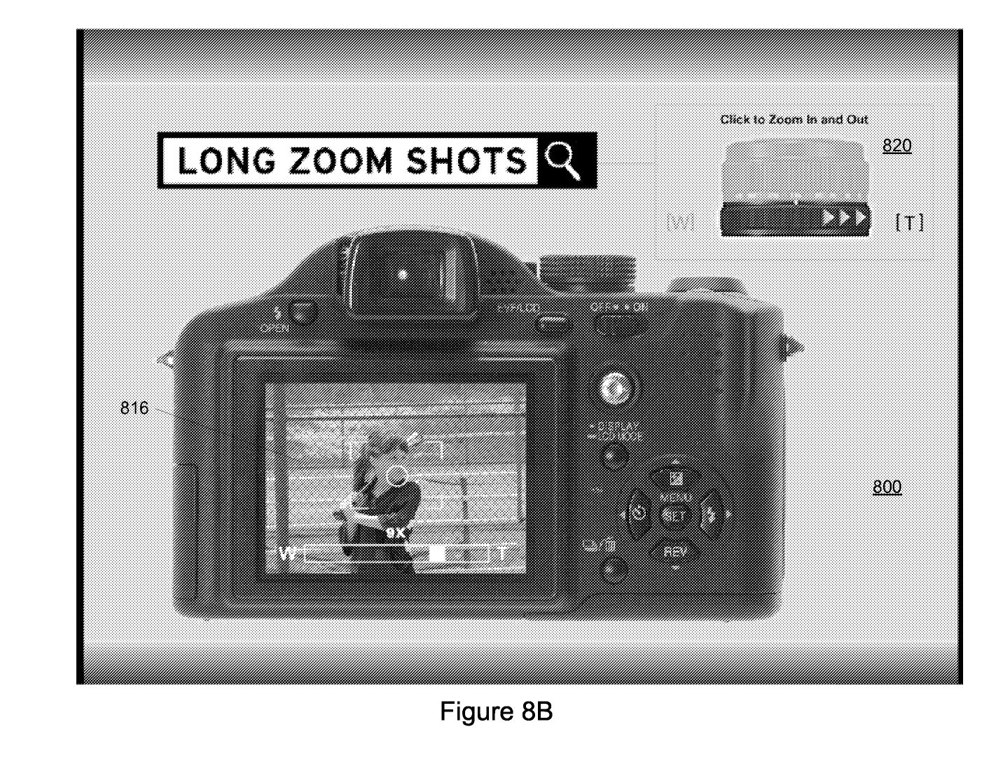

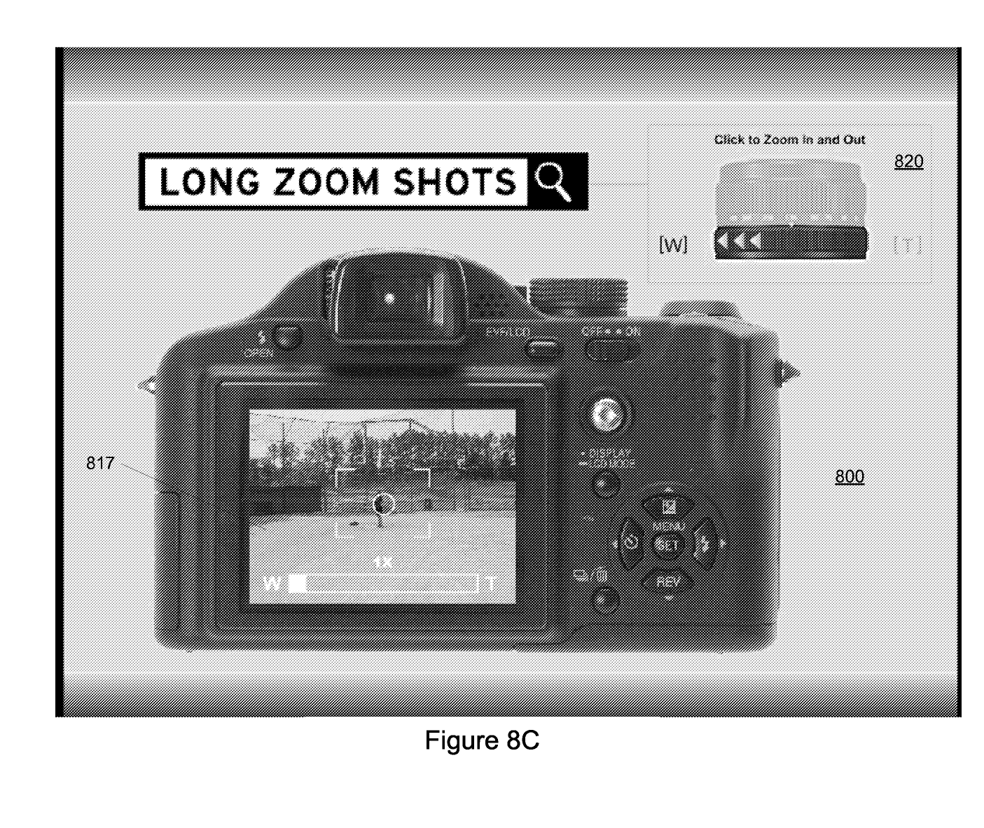

FIGS. 8A-8C illustrate a zoom visualization tool that allows a customer to determine the degree of zoom provided by a particular lens. Zoom visualization tool 800 of FIG. 8A may include an image of a camera 810 and zoom control 820. By selecting zoom in section 825 of zoom control 820, image 815 of camera 810 may be replaced with another image that simulates zooming into image 815 to a certain degree. Selecting zoom out section 826 of zoom control 820, on the other hand, may cause image 815 to be replaced with another image that simulates zooming out of image 815 a particular amount. For example, FIGS. 8B and 8C illustrate camera 810 displaying zoomed in image 816 and zoomed out image 817 (corresponding to image 815), respectively, in response to user interaction with control 820. Zoom visualization tool 800 may store a series of images that represent different degrees of zooming for a particular scene to display the image corresponding to a current simulated zoom setting.

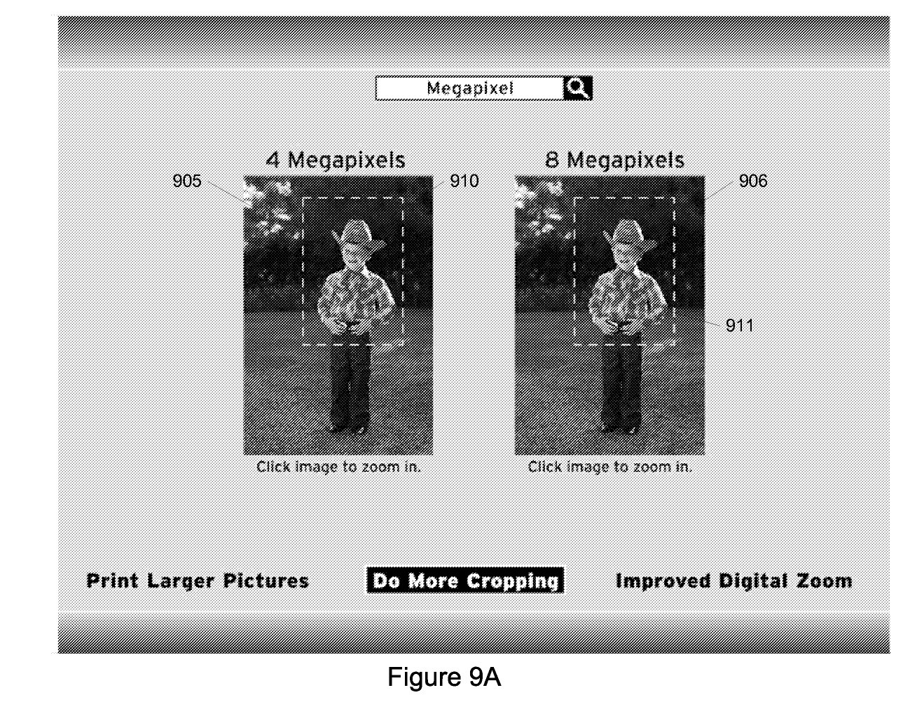

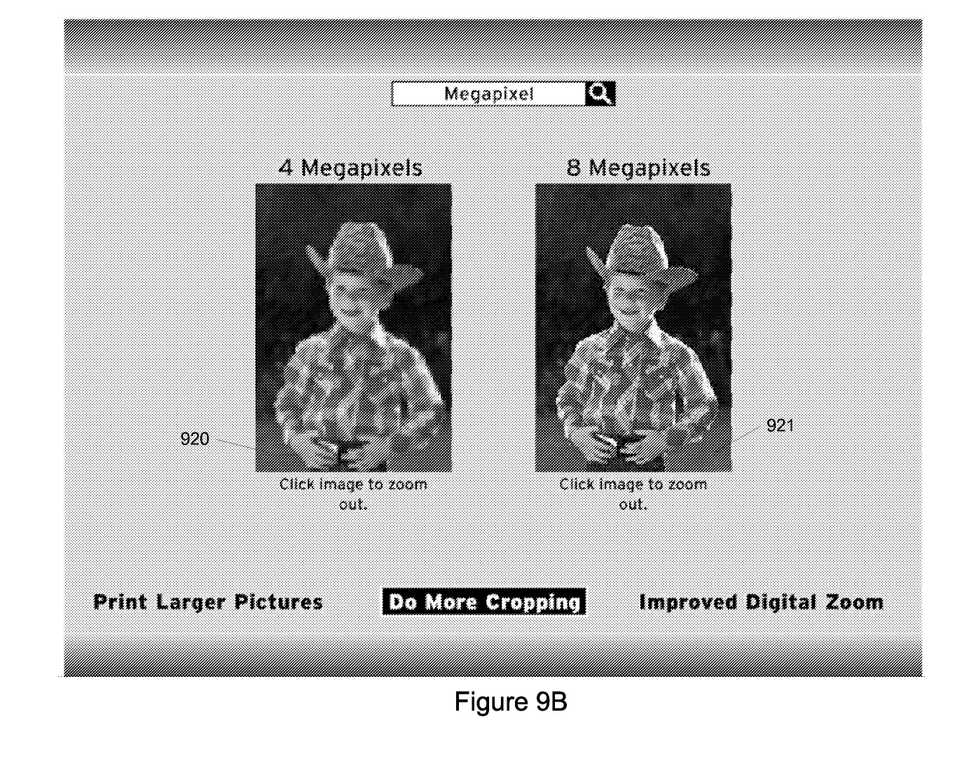

FIGS. 9A and 9B illustrate a megapixel differentiation tool for cropping and enlarging images 905 and 906. In FIG. 9A, images 905 and 906 are displayed in their entirety. Image 905 represents a picture taken with a 4 megapixel camera while image 906 represents a picture taken with an 8 megapixel camera. Crop regions 910 and 911 reflect the portion of the image a user may want to retain while cropping out the remainder of each image 905 and 906. FIG. 9B illustrates images 920 and 921 that reflect images 905 and 906 of FIG. 9A in a cropped state where only the portion of images 905 and 906 within crop regions 910 and 911 of FIG. 9A have been retained. Images 920 and 921 have further been enlarged to the size of original images 905 and 906 of FIG. 9A. As a result, the pixelation and degradation in picture quality may be visualized.

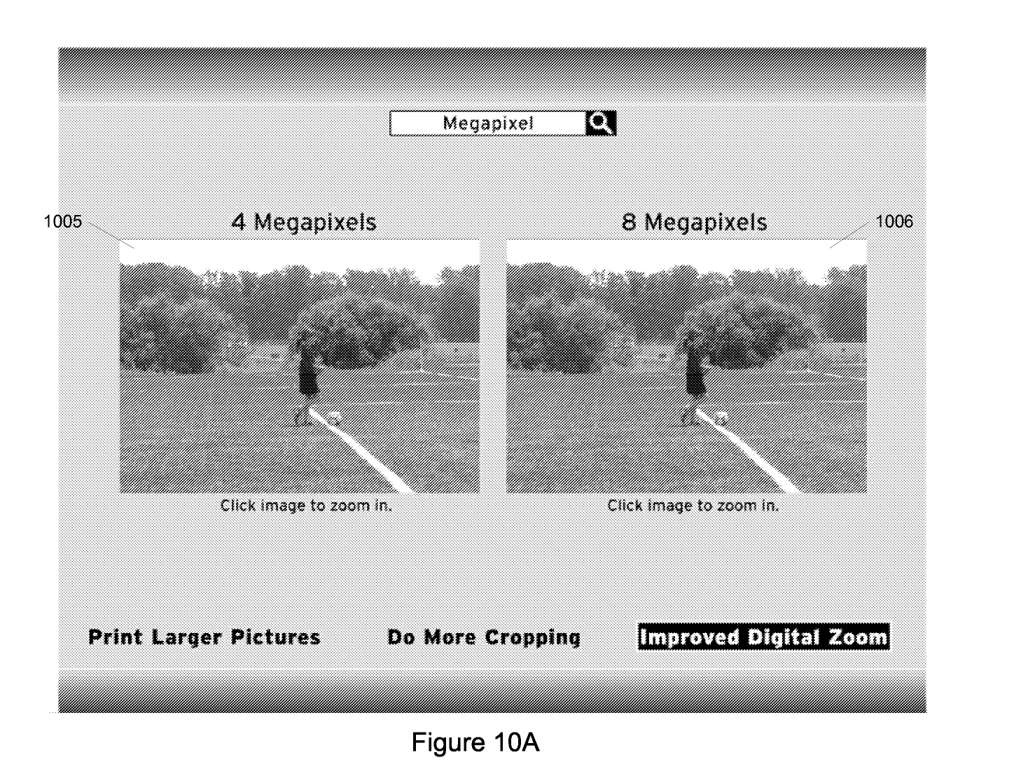

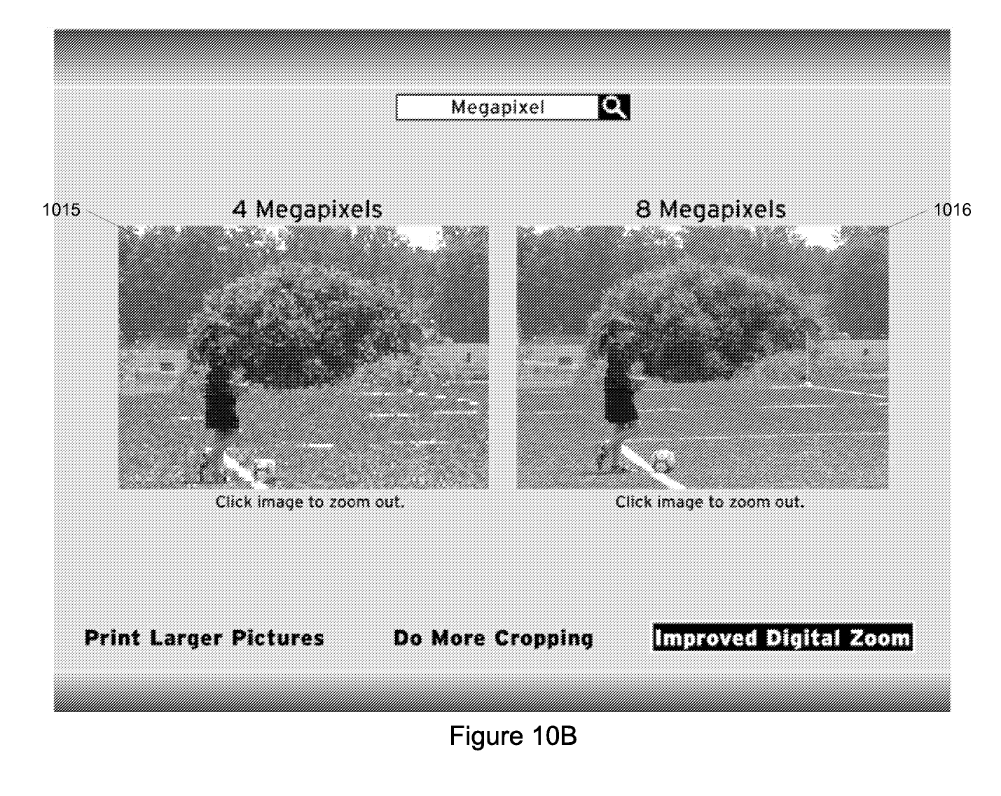

FIGS. 10A and 10B illustrate a megapixel differentiation tool for zooming in images 1005 and 1006. In FIG. 10A, original images 1005 and 1006 may be displayed. Upon a user interacting with one or both of images 1005 and 1006, a zooming in of images 1005 and 1006 may be simulated, resulting in images 1015 and 1016 of FIG. 10B. By viewing zoomed in images 1015 and 1016, a customer or user may be able to visualize differences in picture quality based on the amount of megapixels captured by a camera.

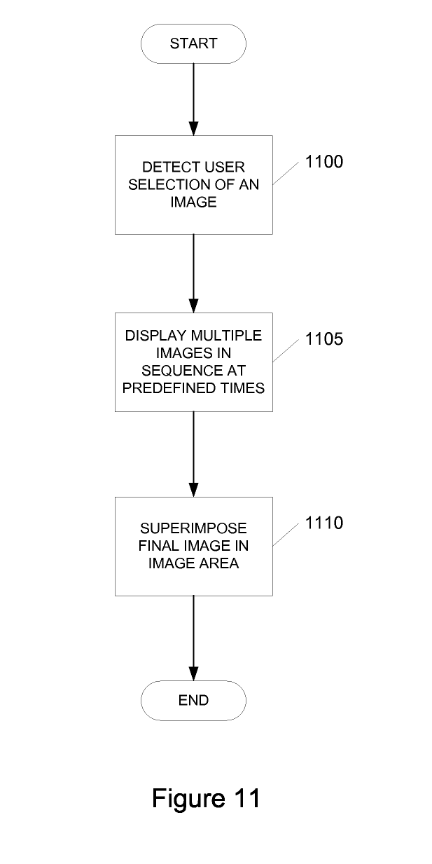

FIG. 11 is a flowchart illustrating a method for visualizing differences in picture quality. In step 1100, a user selection of an image may be detected by a megapixel visualization tool. For example, a user may click on the image or perform other interaction on the image. The interaction and response may be predefined by the tool or system. In response to the interaction by the user, multiple images representing varying degrees of enlargement or zoom may be displayed in sequence at a predefined interval in step 1105. For example, images may be displayed every half a second. In step 1110, after the last of the multiple images have been displayed, a final image, representing the zoomed in or enlarged image, may replace or be superimposed on the last of the multiple sequenced images.

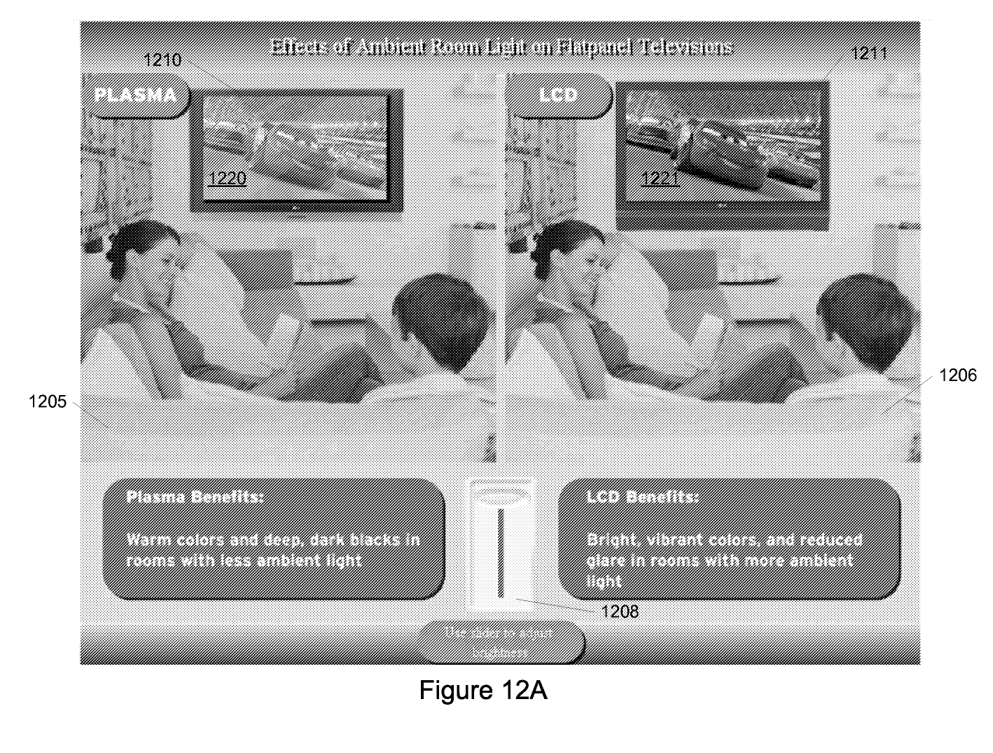

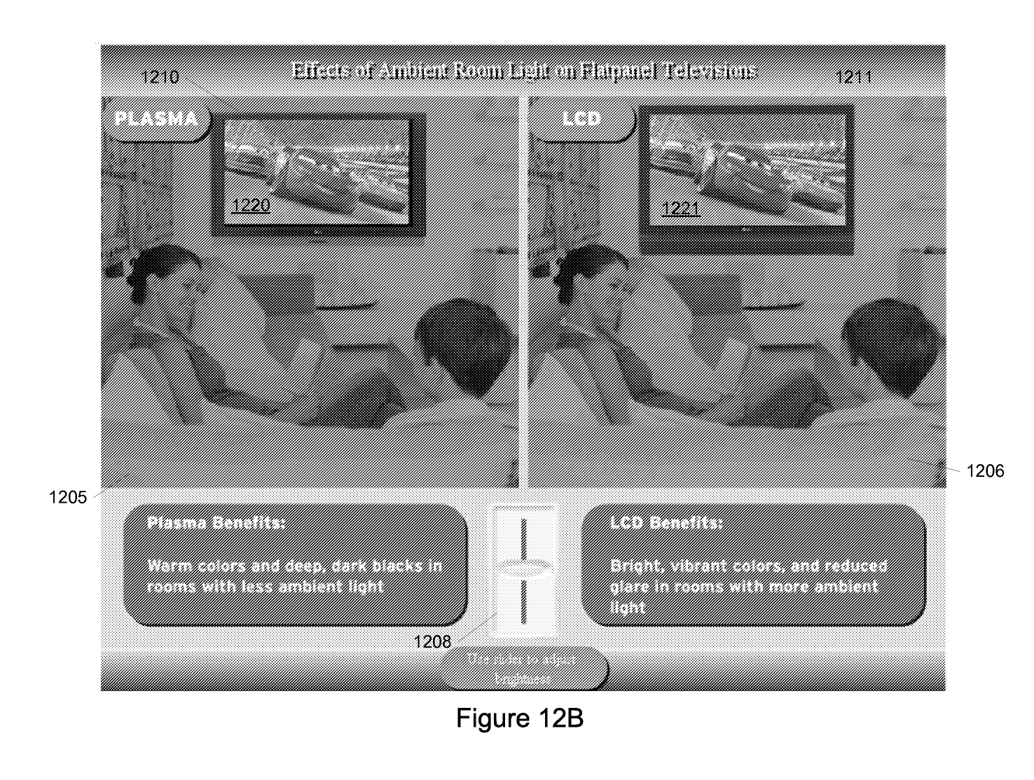

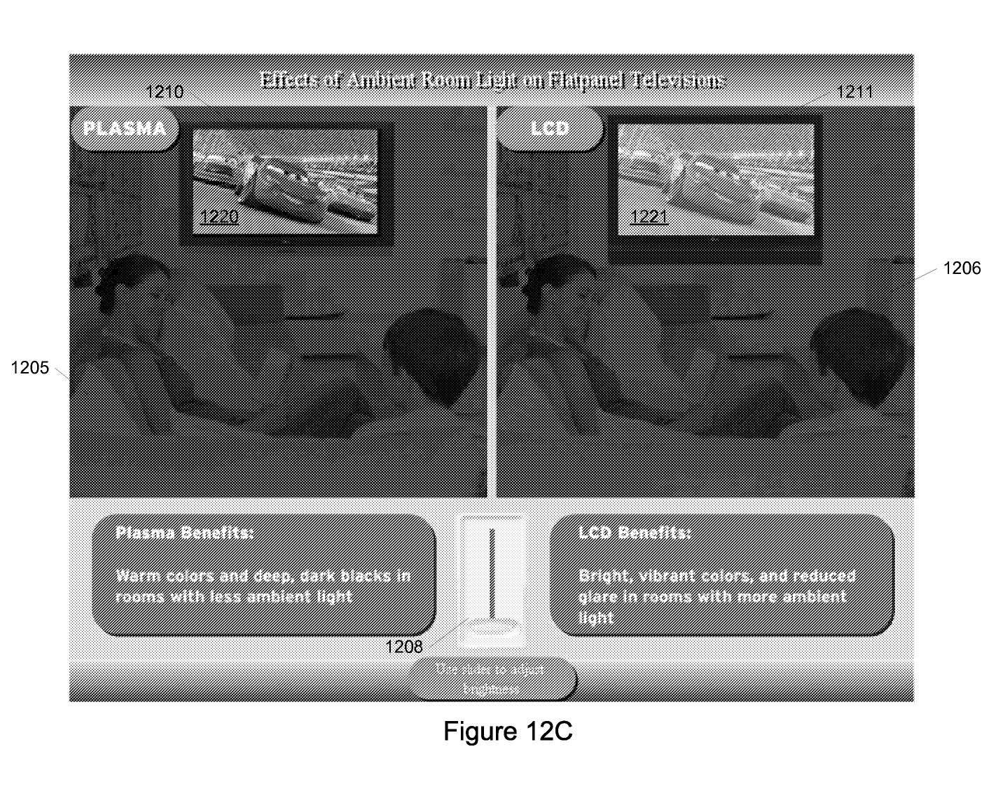

FIGS. 12A-12C illustrates an ambient light effect tool for determining differences in television technology. For example, in FIG. 12A, section 1205 may display simulated plasma television 1210 in a room while section 1206 may display simulated LCD television 1211 in the same room. Light control slider 1208 may be situated in a bottom portion of the tool for controlling the darkness/brightness of the simulated rooms.

Sliding light control slider 1208 may result in a darkening or dimming of each of sections 1205 and 1206. The simulated darkening of the rooms may be used to demonstrate the effect(s) of light on plasma display 1210 and LCD display 1211. In one or more arrangements, plasma display 1210 and LCD display 1211 may include images 1220 and 1221 on a separate layer than the rest of the image in sections 1205 and 1206. In other words, adjusting slider 1208 may result in different effects on plasma image 1220 and LCD image 1221 than on the other image portions (i.e., the rest of the simulated room) of sections 1205 and 1206. Including plasma image 1220 and LCD image 1221 on separate layers allows for the look of images 1220 and 1221 to be adjusted in accordance with how plasma displays and LCD displays would look in real life under similar lighting.

Accordingly, in FIGS. 12B and 12C, a viewer may be able to visualize the effects of dimming the simulated lighting in the rooms displayed in sections 1205 and 1206. In particular, as the lighting is dimmed, images 1220 and 1221 displayed on plasma display 1210 and LCD display 1211, respectively, change in contrast and other characteristics of image quality. For example, image 1220 of plasma display 1210 may become sharper in environments with less ambient light while image 1221 of LCD display 1211 may become more washed out as the ambient light is dimmed. To produce the transition images corresponding to intermediate light levels, a first image and a second image corresponding to the two light extremes may initially be defined. Intermediate images may then be interpolated based on a number of desired intermediate images. Accordingly, as slider 1208 is adjusted, images 1220 and/or 1221 may be replaced by the appropriate image.

While aspects of the guided sales system have been described in relation to a sales person using such a system to guide a customer, the guided sales system may also be deployed for independent use by the customer. For example, the guided sales system may be deployed on a self-service kiosk computer in a store or on a store website. Thus, a customer may independently access the guided sales system in the store or at home. Solution information collected and/or determined during a customer's independent use of a guided sales system may be saved to a store or corporate database and later retrieved by either the customer or an in-store sales person. In one example, a customer initiating a sales solution at home through a store website may later go to the store and pull up the sales solution he or she had previously started at home.

Additionally or alternatively, a guided sales system as described herein may further allow the entry of drawings corresponding to other environments in addition to rooms. For example, the guided sales system may allow a customer to draw a car interior if the customer is looking for a new car stereo. In another example, a customer may draw a boat shape or design if the customer is looking for an on-deck entertainment system. One of skill in the art will appreciate that a variety of other types of drawings may be entered in a guided sales system.

While illustrative systems and methods as described herein embodying various aspects of the present invention are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

1. A method for guiding a user in determining a product recommendation using a computing device, the method comprising the steps of:
prompting the user with a question, wherein the question is displayed on a display device;
receiving user input corresponding to a response to the question;
generating a product list including one or more products that match one or more product parameters specified in the response;
launching a learning tool, wherein the learning tool simulates one or more aspects of at least one of the one or more products;
determining a recommended product from the product list; and
generating a recommendation based on the recommended product.

2. The method of claim 1, further comprising the step of prior to prompting the user with a question, retrieving an existing sales solution including information stored from one or more previous sales sessions.

3. The method of claim 2, wherein the one or more previous sales sessions were conducted using a device other than the computing device.

4. The method of claim 1, wherein the user input is received through the display device.

5. The method of claim 1, further comprising the step of refining the product list based on at least one of a location parameter and an inventory parameter.

6. The method of claim 1, wherein the learning tool corresponds to the question.

7. The method of claim 1, further comprising electronically transmitting the recommendation to a point of sale system.

8. The method of claim 1, further comprising the step of receiving input corresponding to a free-form drawing.

9. The method of claim 8, wherein the free-form drawing corresponds to at least one of a room design, a car design and a boat design.

10. The method of claim 1, wherein the step of generating the recommendation includes generating a sales ticket including a product bar code associated with the recommended product.

11. The method of claim 1, wherein the learning tool includes audio content.

12. The method of claim 1, wherein the step of launching the learning tool further comprises:
displaying a menu of available learning tools, wherein the available learning tools include product simulations; and
receiving input corresponding to a selection of the learning tool from the available learning tools.

13. The method of claim 1, wherein the learning tool includes a zoom simulation tool.

14. The method of claim 1, wherein the learning tool includes a camera filter simulation tool.

15. The method of claim 1, wherein the learning tool includes a megapixel differentiation simulation tool.

16. The method of claim 1, wherein the learning tool includes an ambient light effect simulation tool.

17. The method of claim 1, wherein the learning tool includes a resolution magnification simulation tool.

18. The method of claim 17, wherein the resolution magnification simulation tool includes a non-magnified image layered on top of a magnified image and a magnification cursor, the magnification cursor including a viewing area, wherein a first portion of the non-magnified image within the viewing area is set at a first transparency and a second portion of the non-magnified image outside of the viewing area is set at a second transparency.

19. The method of claim 1, further comprising the step of transmitting the recommendation to a remote system for storage at a predefined time.

20. A device for providing sales guidance, the device comprising:
a display device;
a processor; and
memory storing computer readable instructions that, when executed by the processor, cause the device to perform a method comprising the steps of:
displaying a question on the display device;
receiving a response to the question;
generating a product list including one or more products that match one or more product parameters specified in the response;
launching a learning tool, wherein the learning tool simulates one or more aspects of at least one of the one or more products;
determining a recommended product from the product list; and
generating a recommendation based on the recommended product.

21. The device of claim 20, wherein the device is a mobile computing device.

22. The device of claim 20, further comprising a communication device configured to transmit and store the recommendation in a remote server.

23. The device of claim 20, wherein the memory further stores instructions for performing the step of receiving drawing input, wherein the drawing input includes electronic ink entered through the display device.

24. The device of claim 23, wherein the one or more product parameters includes at least one of a room size, a room type, a currently owned product and an intended usage.

25. The device of claim 20, wherein the memory further stores instructions for performing the step of generating a sales ticket including a bar code associated with the recommended product.

26. The device of claim 20, wherein the learning tool includes audio content.

27. The device of claim 20, wherein the learning tool includes a camera filter simulation tool.

28. The device of claim 27, wherein the camera filter simulation tool includes a first image, a second image, a filter cursor, the filter cursor having a viewing area and an adjustment tab, wherein the adjustment tab controls a transparency of a portion of the first image inside the viewing area.

29. A computer readable medium storing computer readable instructions that, when executed, cause a display of a computing device to display a user interface corresponding to a guided sales system, the user interface comprising:
a first display portion displaying a navigation panel having a plurality of options corresponding to a plurality of features provided by the guided sales system;
a second display portion displaying an information panel including information corresponding to a currently selected option of the plurality of options in the navigation panel; and
a third display portion displaying a data log associated with the currently selected option, wherein the data log includes data entered into the guided sales system.

30. The computer readable medium of claim 29, wherein the plurality of options includes at least one of a product finder option, a room design option, a currently owned option, an about you option, a note entry option, a learning tool option and a recommendation option.

31. The computer readable medium of claim 30, wherein the currently selected option corresponds to the about you option and wherein the information panel displays one or more sales questions, and wherein the data log includes responses to the one or more sales questions.

32. The computer readable medium of claim 30, wherein the currently selected option corresponds to the product finder option and wherein the user interface further comprises a fourth display portion displaying a plurality of product categories.

33. A mobile device for providing product sales guidance, the device comprising:
a display device, wherein the display device is at least one of a touch-sensitive display device and stylus-sensitive display device;
a processor; and
memory storing computer readable instructions that, when executed by the processor, cause the mobile device to perform a method comprising the steps of:
prompting a user with a question, wherein the question is displayed on the display device;
receiving a response to the question;
receiving drawing input through the display device, wherein the drawing input includes electronic ink representing at least one of a room, a car and a boat;
storing data associated with the drawing input and the response in the memory, wherein the data is transmitted to a remote server at a predefined time;
determining one or more product parameters from the response to the question and the drawing input;
generating a product list including one or more products that match the determined one or more product parameters, wherein the product list is generated prior to a product recommendation being made; and
launching a learning tool that simulates one or more aspects of at least one of the one or more products, wherein the learning tool is selected for launch based on a correspondence between the learning tool and a content of the question.

34. The mobile device of claim 33, wherein the learning tool includes at least one of a zoom simulation tool, a camera filter simulation tool, a megapixel differentiation simulation tool, an ambient light effect simulation tool and a resolution magnification simulation tool.

35. A computer readable medium storing computer executable instructions that, when executed by a processor, cause the processor to perform a method comprising:
displaying a camera zoom control in association with a product sales page;
displaying a first image simulating a photograph taken by a camera;
receiving input in the zoom control; and
displaying a second image simulating at least one of: a zoomed-out photograph or a zoomed-in photograph.

36. The computer readable medium of claim 35, wherein the product sales page is a webpage.

37. The computer readable medium of claim 35, wherein the zoom control and the second image are displayed simultaneously.

38. The computer readable medium of claim 35, wherein the camera zoom control is displayed in response to a request for sales guidance.

39. The computer readable medium of claim 35, further comprising: displaying at least a simulated portion of the camera in association with the zoom control.

40. The computer readable medium of claim 35, wherein the camera zoom control is displayed in an applet.

41. The computer readable medium of claim 40, wherein the applet is launched from the product sales page.

42. A computer readable medium storing computer executable instructions that, when executed by a processor, cause the processor to perform a method comprising:
displaying a first image in a first portion of a display, wherein the first image simulates a first photograph in a first resolution;
displaying a second image simulating a second photograph in a second resolution simultaneously with the first image and in a second portion of the display;
receiving input corresponding to a crop command, wherein the crop command includes cropping a portion of at least one of: the first image and the second image;
in response to the crop command, displaying a third image simulating the first photograph in a cropped state in the first portion of the display.

43. The computer readable medium of claim 42, wherein the method further comprises:
displaying a fourth image simulating the second photograph in the cropped state in the second portion of the display.

44. The computer readable medium of claim 42, wherein the first photograph and the second photograph are the same.

45. The computer readable medium of claim 42, wherein the input corresponding to the crop command is received through interaction with the first photograph.

46. The computer readable medium of claim 42, wherein the second resolution is greater than the first resolution.

47. The computer readable medium of claim 42, wherein the first image and second image are displayed in association with a product sales page.

48. A computer readable medium storing computer readable instructions that, when executed, cause a processor to perform a method comprising::
prompting the user with a question, wherein the question is displayed on a display device;
receiving user input corresponding to a response to the question, wherein the response identifies one or more products; and
launching a learning tool, wherein the learning tool simulates one or more aspects of at least one of the one or more products.

49. The computer readable medium of claim 48, wherein the learning tool comprises a crop simulation tool.

50. The computer readable medium of claim 48, wherein the learning tool comprises a zoom simulation tool.

51. The computer readable medium of claim 48, wherein the response to the question indicates a request to learn more about the one or more products.

52. A method comprising:
displaying a camera zoom control in association with a product sales page;
displaying a first image simulating a photograph taken by a camera;
receiving input in the zoom control; and
displaying a second image simulating at least one of: a zoomed-out photograph or a zoomed-in photograph.

53. A method comprising:
displaying a first image in a first portion of a display, wherein the first image simulates a first photograph in a first resolution;
displaying a second image simulating a second photograph in a second resolution simultaneously with the first image and in a second portion of the display;
receiving input corresponding to a crop command, wherein the crop command includes cropping a portion of at least one of: the first image and the second image;
in response to the crop command, displaying a third image simulating the first photograph in a cropped state in the first portion of the display.

54. A method for guiding a user in selecting a product, the method comprising:
prompting the user with a question, wherein the question is displayed on a display device;
receiving user input corresponding to a response to the question, wherein the response identifies one or more products; and
launching a learning tool, wherein the learning tool simulates one or more aspects of at least one of the one or more products.
